(19) United States
(12) Patent Application Publication
(10) Pub. No.: US 2016/0227367 A1
(43) Pub. Date: Aug. 4, 2016

(54) METHOD OF PROVIDING POSITIONING DATA TO MOBILE DEVICE

(71) Applicant: SENSEWHERE LIMITED, Edinburgh (GB)

(72) Inventors: Firas ALSEHLY, Edinburgh (GB); Zankar Upendrakumar SEVAK, Edinburgh (GB); Tughrul Sati ARSLAN, Edinburgh (GB)

(21) Appl. No.: 15/014,393

(22) Filed: Feb. 3, 2016

Related U.S. Application Data
(60) Provisional application No. 62/111,851, filed on Feb. 4, 2015.

(51) Int. Cl. H04W 4/02

(52) U.S. Cl. CPC H04W 4/021; H04W 4/025

(57) ABSTRACT

The invention provides a method of providing positioning data to a mobile user device comprising a positioning module for estimating a location of the mobile user device, the method comprising: providing a database comprising positioning data for use by the positioning module of the mobile user device to estimate the location of the mobile user device; providing customised user data specific to a user of the mobile user device; selecting one or more subsets of positioning data from the positioning data provided in the said database responsive to a determination that the said subsets of positioning data meet one or more relevance criteria relating to the said customised user data; and providing the selected subsets of positioning data to the mobile user device.

### FIELD OF THE INVENTION

The invention relates to: a method of providing positioning data to a mobile user device; data processing apparatus for providing positioning data to a mobile user device; a system comprising a plurality of mobile user devices and a controller; a method of generating customised user data specific to a user of a mobile user device; data processing apparatus for generating customised user data specific to a user of a mobile user device; and a non-transitory computer readable medium retrievably storing computer readable code for causing one or more computers to perform the steps of a method of providing positioning data to a mobile user device or as a controller of data processing apparatus for providing positioning data to a mobile user device.

### BACKGROUND TO THE INVENTION

It is known to provide a positioning system in which mobile user devices make an estimate of their position by measuring electromagnetic signals from electromagnetic signal sources, such as wireless access points and other radio-frequency beacons, and then using locally-stored data concerning the wireless access points to estimate their position. This positioning data is received from a centralised server database of positioning data across a wide geographic area. Data concerning the position of electromagnetic signals sources obtained from signal measurements made by individual mobile user devices are fed back to a controller, which uses this data to maintain and update the server database. This approach to maintaining the server database, using measurements from individual mobile user devices, has been referred to as crowd sourcing.

In order for such systems to work, positioning data must be transmitted from a server database to individual mobile user devices, so that they may make estimates of their position. Typically mobile user devices will receive positioning data concerning a region surrounding their current location, and it is known for mobile user devices to cache positioning data concerning geographical locations where they have recently been, or regularly go, to avoid receiving the same data over and over again. This can lead to them using out of date data.

Some aspects of the invention address the technical problem of reducing the amount of data which a mobile user device must receive from a server database in order to provide reliable positioning estimates using measurements of signals from electromagnetic signal sources. In particular, mobile user devices increase power consumption when they are receiving data over wireless communications channels, particularly when they receive the data using a cellular network communication system (such as 2G, 3G, 3.5G, 4G mobile communications network), and it is desirable to reduce this power consumption to maximise the time between battery recharges.

### SUMMARY OF THE INVENTION

A first aspect of the invention provides a method of providing positioning data to a mobile user device comprising a positioning module for estimating a location of the mobile user device, the method comprising: providing a (e.g. controller or server) database comprising positioning data for use by the positioning module of the mobile user device to estimate the location of the mobile user device; providing customised user data specific to a user of the mobile user device; selecting one or more subsets of positioning data from the positioning data provided in the said database (typically less than all of the positioning data provided in the said database) responsive to a determination that the said subsets of positioning data meet one or more relevance criteria relating to the said customised user data; and providing the selected subsets of positioning data to the mobile user device.

A second aspect of the invention provides data processing apparatus comprising: a mobile user device comprising a positioning module for estimating a location of the mobile user device and a memory for storing positioning data; and a controller comprising: a (e.g. controller or server) database storing positioning data for use by the positioning module of the mobile user device to estimate the location of the mobile user device; a memory storing customised user data specific to a user of the mobile user device; a selection module programmed to select one or more subsets of positioning data from the positioning data provided in the said database (typically less than all of the positioning data provided in the said database) responsive to a determination that the said subsets of positioning data meet one or more relevance criteria relating to the said customised user data; and a data transfer module programmed to provide the selected subsets of positioning data to the mobile user device.

By providing selected subsets of the positioning data to the mobile user device based on customised user data, it can be ensured that only relevant positioning data is transmitted to and stored by the mobile user device, thereby reducing unnecessary data transfer and associated bandwidth and power consumption.

It may be that the method according to the first aspect of the invention is performed on, and it may be that the controller is provided on, one or more servers remote from the mobile user device or partly on one or more servers remote from the mobile user device and partly on the mobile user device. Preferably the database is provided on one or more servers remote from the mobile user device. Preferably the customised user data is provided on one or more servers remote from the mobile user device. Preferably the step of selecting one or more subsets of positioning data from the positioning data provided in the said database (typically less than all of the positioning data provided in the said database) responsive to a determination that the said subsets of positioning data meet one or more relevance criteria relating to the said customised user data is performed (or the selection module is provided) on one or more servers remote from the user device. Preferably the step of providing the selected subsets of positioning data to the mobile user device comprises transmitting the said selected subsets of positioning data to the mobile user device from (or the data transfer module is provided on) one or more servers remote from the mobile user device.

It may be that the method comprises (e.g. the controller) determining (or the controller may be programmed to determine) that one or more subsets of positioning data from the positioning data provided in the database meet one or more relevance criteria relating to the customised user data.

The method may comprise transmitting (or the controller may be programmed to transmit) the selected subset(s) of positioning data (e.g. from one or more servers comprising the database, the said one or more servers being remote from the mobile user device) to the mobile user device in response to a request from the mobile user device. The method may comprise determining (or the controller may be programmed to determine) that one or more subsets of positioning data from the positioning data provided in the database meet one or more relevance criteria relating to the customised user data responsive to a or the request from the mobile user device. The method may comprise selecting (or the selection module may be programmed to select) the one or more subsets of positioning data from the positioning data provided in the said database (typically less than all of the positioning data provided in the said database) responsive to a determination that the said subsets of positioning data meet one or more relevance criteria relating to the said customised user data and responsive to a or the request from the mobile user device.

Alternatively the method may comprise (the controller) transmitting (“pushing”) the selected subset(s) of positioning data to the mobile user device automatically (i.e. without having to receive a request from the mobile user device), for example at (or in advance of) a time provided in or derived from the said customised user data or, in another example, periodically. The method may comprise determining (or the controller may be programmed to determine) that one or more subsets of positioning data from the positioning data provided in the database meet one or more relevance criteria relating to the customised user data automatically (i.e. without having to receive a request from the mobile user device), for example at (or in advance of) a time provided in or derived from the said customised user data or, in another example, periodically. The method may comprise selecting (or the selection module may be programmed to select) the one or more subsets of positioning data from the positioning data provided in the said database (typically less than all of the positioning data provided in the said database) responsive to a determination that the said subsets of positioning data meet one or more relevance criteria relating to the said customised user data automatically (i.e. without having to receive a request from the mobile user device), for example at (or in advance of) a time provided in or derived from the said customised user data or, in another example, periodically.

It may be that the method comprises the mobile user device determining (or the mobile user device being programmed to determine) whether to accept positioning data transmitted (by the controller) to the mobile user device. It may be that the method comprises the mobile user device receiving (or the mobile user device may be programmed to receive) positioning data transmitted (e.g. by the controller) to the mobile user device (e.g. if it is determined that it should accept the positioning data). It may be that the method further comprises (e.g. the mobile user device) updating (or the mobile user device being programmed to update) positioning data stored on the mobile user device using the received positioning data.

The modules of the data processing apparatus may be implemented in software, in hardware, or in a combination of software and hardware.

The method may comprise deleting (or the mobile user device may be programmed to delete) positioning data from the mobile user device a predetermined time period after it was stored on the mobile user device. The said predetermined time period is typically provided in, or inferred from, the customised user data.

The method may further comprise the mobile user device selectively storing (or the mobile user device may be programmed to selectively store) positioning data from the database in accordance with a hardware capability of the mobile user device. For example, the method may comprise the mobile user device selectively storing (or the mobile user device may be programmed to selectively store) positioning data from the database relating to a positioning technology employed by a positioning module of the mobile user device (and optionally discarding or rejecting positioning data relating a positioning technology which cannot be employed by the mobile user device). The method may comprise selecting (or the selection module may be programmed to select) one or more subsets of positioning data from the database for use by the said positioning module of the mobile user device and not selecting (or the selection module may be programmed not to select) positioning data comprised in the database for use by a different positioning module not comprised in the said mobile device.

As indicated above, it may be that the database is provided on one or more servers remote from the mobile user device. It may be that the method comprises transmitting (or the data transfer module may be programmed to transmit) the selected data from the server(s) to the mobile user device responsive to a determination that an active data communication channel having a bandwidth (or a typical bandwidth) greater than a predetermined threshold bandwidth is available for transferring data from the server(s) to the mobile user device and/or that a battery of the mobile user device is being charged. For example, the method may comprise transmitting (or the data transfer module may be programmed to transmit) the selected data from the server(s) to the mobile user device responsive to a determination that an active data channel using a particular data communications technology (e.g. 3G mobile telecommunications channel, 4G mobile telecommunications channel, over the fixed line internet by way of a Wi-Fi connection) is available for transferring data from the server(s) to the mobile user device. In one example, the method comprises transmitting (or the data transfer module may be programmed to transmit) the selected data from the server(s) to the mobile user device responsive to a determination that an active connection to a local network (e.g. through a, e.g. Wi-Fi, household router) is available.

It may be that the method comprises transmitting (or the data transfer module is programmed to transmit) the selected subset(s) of positioning data to the mobile user device earlier than the selected subset(s) of positioning data is expected (e.g. from the customised user data) to be required by the mobile user device to estimate its position (or at least earlier than it otherwise would be transmitted to the mobile user device), e.g. responsive to a determination that an active data communication channel having a bandwidth (or a typical bandwidth) greater than a predetermined threshold bandwidth is available for transferring data from the server(s) to the mobile user device and/or that a battery of the mobile user device is being charged.

The customised user data typically comprises data specific to the said user of the mobile user device from which a future geographical location or geographical region of the user can be predicted.

It may be that the customised user data comprises geo-referenced data specific to the said user of the mobile user device from which a future geographical location or geographical region of the user can be predicted.

It may be that one or more of the selected subsets of positioning data relate to (e.g. are suitable for use by the positioning module to estimate the position of the mobile user device at) a predicted future geographical location or region of the user determined from the customised user data.

It may be that the customised user data comprises one or more metrics, each of the said metrics being geo-referenced to a geographical location or geographical region, each of the said metrics providing an indication of a probability that the said user of the mobile user device will occupy the geographical location or geographical region geo-referenced to that metric.

It may be that the customised user data comprises data concerning one or more (preferably two or more, even more preferably three or more) past activities or past locations of the user.

Typically, the geographical locations or geographical regions to which the said metrics are geo-referenced are geographical locations or geographical regions the said user of the mobile user device has occupied previously. It may be that geographical locations or geographical regions the said user of the mobile user device has occupied previously are inferred from geographical locations or geographical regions the said mobile user device has occupied previously.

Typically the positioning data comprised in the said database (and typically of the selected subsets of positioning data provided to the mobile user device) is grouped or stored with reference to a plurality of discrete geographical regions.

It may be that the discrete geographical regions are of uniform shape and size, but more typically the discrete geographical regions are of different shapes and sizes.

It may be that the method further comprises selecting (or the selection module may be programmed to select) from the positioning data provided in the said database a subset of positioning data referenced to one of the said discrete geographical regions responsive to a determination that the said discrete geographical region meets one or more relevance criteria relating to the said customised user data.

It may be that the method comprises selecting (or the selection module may be programmed to select) the said subset of positioning data referenced to one of the said discrete geographical regions responsive to a determination that the discrete geographical region associated with the selected subset meets one or more geographical relevance criteria relating to the said customised user data.

It may be that the method comprises selecting (or the selection module may be programmed to select) a said subset of positioning data referenced to one of the said discrete geographical regions responsive to a determination that the discrete geographical region associated with the selected subset comprises a geographical location or geographical region previously occupied by the said user of the mobile user device.

It may be that one or more of the said metrics are binary metrics. More typically the metrics (or at least one or more of the said metrics) may have one of three or more possible values along a (e.g. continuous) scale. For example, one or more of the said metrics may comprise a frequency count of the number of times the said user of the mobile user device has occupied a geographical location or geographical region.

The customised user data may comprise one or more time references associated with each of one or more of the said metrics, the said time references concerning (e.g. indicative of) one or more times at which the user has previously occupied the geographical location or geographical region to which the said metric is geo-referenced. The said time references may comprise one or more time ranges (e.g. hours of the day (which may be specific to a day of the week or specific to one or more groups of days of the week) and/or one or more days of the week).

The step of selecting one or more subsets of positioning data from the database may comprise: determining (or the controller may be programmed to determine) from the said metrics provided in the customised user data one or more candidate metrics meeting one or more relevance criteria (e.g. metrics having a metric value exceeding a predetermined threshold metric value); and selecting (or the selection module may be programmed to select) from the database one or more subsets of positioning data concerning a geographical location or geographical region to which the said candidate metrics are geo-referenced.

It may be that the method comprises (e.g. the positioning module of mobile user device) using (or the positioning module of the mobile user device may be programmed to use) positioning data from one or more of the selected subsets of positioning data to estimate a (e.g. current) location of the mobile user device (e.g. when the mobile user device is at a geographical location or geographical region to which the said subset(s) are georeferenced).

It may be that the customised user data comprises customised user activity data relating to one or more preferred or probable activities of the said user of the mobile user device. For example, it may be that the customised user data comprises one or more activity categories relevant to one or more activities previously performed (or performable) by the user (e.g. at a geographical location or a geographical region previously occupied by the user). It may be that the method comprises selecting (or the selection module is programmed to select) one or more subsets of positioning data from the database responsive to a determination (typically by the controller) that the said subset(s) are associated (e.g. in the database) with one or more activity categories relevant to one or more said activity categories provided in the customised user data.

It may be that the said customised user data comprises data concerning (e.g. data indicative of) one or more activity patterns of the said user of the mobile user device.

It may be that the said one or more activity patterns comprise one or more patterns of movement of the said user of the mobile user device. Patterns of movement of the user may be inferred from patterns of movement of the device. A pattern of movement may comprise a repeated (e.g. base or home) geographical location or geographical region occupied by the said user of the mobile user device (or a geographical location or geographical region occupied by the said user of the mobile user device for a time period exceeding a predetermined threshold time period). Additionally or alternatively a pattern of movement may comprise a repeated sequence of geographical locations or geographical regions occupied by the said user of the mobile user device. The data concerning the said pattern of movement may comprise a natural language keyword. For example, the natural language keyword “home” may be associated with a base or home location. The method may comprising using (or the controller may be programmed to use) customised user data concerning a said pattern of movement to determine a time period for which to store positioning data concerning the said pattern of movement on the (memory of the) mobile user device. The mobile user device may be programmed to store the said positioning data for the said time period. For example, one or more subsets of positioning data relating to a “home” geographical location or geographical region may be selected from the database, provided to and permanently stored (albeit it may occasionally be updated) by the mobile user device.

The said data concerning one or more activity patterns of the said user of the mobile user device may comprise one or more time references indicative of one or more times at which the user has a greater probability of occupying a location (or a probability exceeding a predetermined threshold probability that the user will occupy a location) in accordance with the said activity pattern. The said time references may comprise one or more time ranges (e.g. hours of the day (which may be specific to a day of the week or specific to one or more groups of days of the week) and/or one or more days of the week).

It may be that the step of determining that one or more subsets of positioning data from the positioning data provided in the database meet one or more relevance criteria relating to the customised user data comprises determining (or the controller may be programmed to determine) that one or more subsets of positioning data from the positioning data provided in the database meet one or more relevance criteria relating to customised user data concerning one or more activity patterns of the said user of the device. In the event that the data concerning the activity pattern comprises a said time reference, it may be that the determination that the said selected subsets of positioning data meet one or more relevance criteria relating to the said activity pattern is performed (or the controller may be programmed to determine that the said selected subsets of positioning data meet one or more relevance criteria relating to the said activity pattern) taking into account the time reference. For example, it may be that the method comprises determining (or the controller may be programmed to determine) that one or more subsets of positioning data from the positioning data provided in the database meet one or more relevance criteria relating to the data from the customised user data concerning one or more activity patterns at or in advance of a time indicated by the time reference. It may be that the method comprises selecting (or the selection module may be programmed to select) one or more subset(s) of positioning data from the database meeting one or more relevance criteria relating to the said data concerning one or more activity patterns at or in advance of a time indicated by the time reference. It may be that the method comprises providing (or the data transfer module may be programmed to provide) the selected subsets of positioning data to the mobile user device at or in advance of a time indicated by the time reference.

It may be that the method comprises providing (or the data transfer module of the controller may be programmed to provide) to the mobile user device a selected subset of positioning data meeting one or more relevance criteria relating to an activity pattern of the said user of the mobile user device provided in the customised user data at a time at which the user is expected to follow the said activity pattern (in which case an indication of the said time is typically provided in the customised user data—e.g. as indicated above a time reference may be associated with the customised user data concerning each of the one or more activity patterns of the said user of the device). Alternatively, it may be that the method comprises providing (or the data transfer module of the controller may be programmed to provide) to the mobile user device a selected subset of positioning data meeting one or more relevance criteria relating to an activity pattern of the said user of the mobile user device to which the customised user data relates in advance (e.g. up to or at least one hour in advance or up to or at least two hours in advance) of a time at which the user is expected to follow the said activity pattern (in which case an indication of the said time is typically provided in the customised user data—e.g. as indicated above a time reference may be associated with the customised user data concerning each of the one or more activity patterns of the said user of the device).

The said data concerning the activity patterns of the said user of the mobile user device may comprise one or more metrics, each of the said metrics indicating a confidence level that the said user of the mobile user device will occupy a geographical location or geographical region in accordance with the said activity pattern. It may be that each of the said metrics indicate a confidence level that the said user of the mobile user device will occupy a geographical location or geographical region in accordance with the said activity pattern at one or more times indicated by a or the time reference associated with that activity pattern. Alternatively it may be that the metric associated with an activity pattern is adjusted in a first sense (e.g. increased) at or in advance of one or more times at which the user is expected to occupy a geographical location or geographical region in accordance with the said activity pattern, and/or adjusted in a second sense (e.g. decreased) different from the first sense at or in advance of one or more times at which the user is not expected to occupy a geographical location or geographical region in accordance with the said activity pattern. It may be that the method comprises determining one or more candidate activity patterns having a confidence level greater than a predetermined threshold confidence level; and selecting one or more subset(s) of positioning data from the database which meet one or more relevance criteria relating to data from the customised user data concerning the said candidate activity patterns.

The method may comprise storing (or the mobile user device may be programmed to store in its memory) positioning data selected responsive to a determination that it meets one or more relevance criteria relating to an activity pattern of the said user of the mobile user device for a time period commensurate with a confidence level associated with activity pattern in the customised user data (i.e. the greater the confidence level, the longer the time period for which the said positioning data is stored on the mobile user device).

It may be that the said one or more activity patterns comprise one or more activity category patterns of the said user of the mobile user device, each of the said activity category patterns being indicative of a pattern of performance of a particular category (or type) of activity by the said user of the mobile user device.

It may be that the data concerning one or more activity category patterns of the said user of the mobile user device comprises one or more parameters representing one or more categories (or types) of activity previously performed (or performable) by the said user of the mobile user device (e.g. at a geographical location or geographical region previously occupied by the user). For example the data concerning one or more activity category patterns of the said user of the mobile user device may comprise one or more natural language keywords representing a category (or type) of activity previously performed (or performable) by the said user of the mobile user device (e.g. at a geographical location or geographical region previously occupied by the user).

It may be that the positioning data is grouped or stored in the database with reference to one or more activity categories.

It may be that the determination (by the controller) that the said selected subsets of positioning data meet one or more relevance criteria relating to the customised user data comprises comparing data from the customised user data concerning one or more activity category patterns of the said user of the device (e.g. one or more parameters representing a category (or type) of activity previously performed (or performable) by the said user) to the one or more activity categories associated with the positioning data of the database and selecting one or more subset(s) of positioning data from the database whose activity categories meet one or more relevance criteria relating to the said data concerning one or more activity category patterns of the said user. In the event that the data concerning the activity category pattern comprises a time reference, it may be that the determination that the said selected subsets of positioning data meet one or more relevance criteria relating to a said activity category pattern of the said user of the mobile user device is performed (or the controller may be programmed to determine that the said selected subsets of positioning data meet one or more relevance criteria relating to a said activity category pattern) taking into account the time reference. For example, it may be that the method comprises determining (or the controller may be programmed to determine) that one or more subsets of positioning data from the positioning data provided in the database meet one or more relevance criteria relating to the data from the customised user data concerning one or more activity category patterns of the said user of the device at or in advance of a time indicated by the time reference. It may be that the method comprises selecting (or the selection module may be programmed to select) one or more subset(s) of positioning data from the database whose activity categories meet one or more relevance criteria relating to the said data concerning one or more activity category patterns of the said user at or in advance of a time indicated by the time reference. It may be that the method comprises providing (or the data transfer module may be programmed to provide) the selected subsets of positioning data to the mobile user device at or in advance of a time indicated by the time reference.

The said data concerning the activity category patterns of the said user of the mobile user device may comprise one or more metrics, each of the said metrics indicating a confidence level that the said user of the mobile user device will occupy a location in accordance with a said activity category pattern. It may be that each of the said metrics indicate a confidence level that the said user of the mobile user device will occupy a location in accordance with a said activity category pattern at one or more times indicated by a or the time reference associated with that activity category pattern. Alternatively, it may be that the metric associated with an activity category pattern is adjusted in a first sense (e.g. increased) at or in advance of one or more times at which the user is expected to occupy a location in accordance with the activity category pattern, and/or adjusted in a second sense (e.g. decreased) different from the first sense at or in advance of one or more times at which the user is not expected to occupy a location in accordance with the activity category pattern. It may be that the method comprises determining one or more candidate activity category patterns having a confidence level greater than a predetermined threshold confidence level; and selecting one or more subset(s) of positioning data from the database whose activity categories meet one or more relevance criteria relating to the said candidate activity category patterns.

It may be that one or more of the subsets of positioning data selected on the basis that they are associated with one or more activity categories provided in the customised user data relate to a geographical region which does not comprise an estimated (current) location of the mobile user device or a location previously occupied by the said user of the mobile user device.

The customised user data may comprise one or more categories of place. Typically each of the said categories of place is associated in the customised user data with one or more geographical locations or geographical regions which the user has occupied previously. It may be that positioning data in the database of positioning data is grouped or stored with reference to one or more categories of place (which category of place information may be obtained from a third party mapping application such as Google Places or other location specific residential, business or retail directories). It may be that the step of selecting one or more subsets of positioning data from the database of positioning data comprises selecting (or the selection module may be programmed to select) positioning data relating to a category of place provided in the customised user data. It may be that one or more of the subsets of positioning data selected on the basis that they are associated with one or more categories of place provided in the customised user data relate to a geographical region which does not comprise an estimated (current) location of the mobile user device or a location previously occupied by the said user of the mobile user device.

It may be that the data concerning one or more activity patterns of the user comprises one or more place category patterns of the said user of the mobile user device, each of the said place category patterns being indicative of a pattern of a particular category (or type) of place visited by the said user of the mobile user device (which may be inferred from categories of place visited by the mobile user device).

It may be that the data concerning one or more place category patterns of the said user of the mobile user device comprises one or more parameters representing one or more categories (or types) of place previously visited by the said user of the mobile user device. For example the data concerning one or more place category patterns may comprise one or more natural language keywords representing a category (or type) of place previously visited by the said user of the mobile user device.

It may be that the positioning data is grouped or stored in the database with reference to one or more categories of place.

It may be that the determination (by the controller) that the said selected subsets of positioning data meet one or more relevance criteria relating to the customised user data comprises comparing data (e.g. a parameter) from the customised user data concerning a place category pattern of the user to the one or more categories of place associated with the positioning data of the database and selecting one or more subset(s) of positioning data from the database whose categories of place meet one or more relevance criteria relating to the said data (e.g. parameter) concerning the place category pattern of the user. In the event that the data concerning the place category pattern comprises a time reference, it may be that the determination that the said selected subsets of positioning data meet one or more relevance criteria relating to a said place category pattern of the said user of the mobile user device is performed (or the controller may be programmed to determine that the said selected subsets of positioning data meet one or more relevance criteria relating to a said place category pattern) taking into account the time reference. For example, it may be that the method comprises determining (or the controller may be programmed to determine) that one or more subsets of positioning data from the positioning data provided in the database meet one or more relevance criteria relating to the data from the customised user data concerning one or more place category patterns of the said user of the device at or in advance of a time indicated by the time reference. It may be that the method comprises selecting (or the selection module may be programmed to select) one or more subset(s) of positioning data from the database whose place categories meet one or more relevance criteria relating to the said data concerning one or more place category patterns of the said user at or in advance of a time indicated by the time reference. It may be that the method comprises providing (or the data transfer module may be programmed to provide) the selected subsets of positioning data to the mobile user device at or in advance of a time indicated by the time reference.

The said data concerning one or more place category patterns of the said user of the mobile user device may comprise one or more metrics indicating a confidence level that the said user of the mobile user device will visit a place of a category in accordance with a said place category pattern. It may be that the said metrics indicate a confidence level that the said user of the mobile user device will visit a place of a category in accordance with a said place category pattern at one or more times indicated by a or the time reference associated with that place category pattern. Alternatively, it may be that the metric associated with a place category pattern is adjusted in a first sense (e.g. increased) at or in advance of one or more times at which the user is expected to visit a place of a category in accordance with the place category pattern, and/or adjusted in a second sense (e.g. decreased) different from the first sense at or in advance of one or more times at which the user is not expected to visit a place of a category in accordance with the place category pattern. It may be that the method comprises determining one or more candidate place category patterns having a confidence level greater than a predetermined threshold confidence level; and selecting one or more subset(s) of positioning data from the database whose place categories meet one or more relevance criteria relating to data from the customised user data concerning the said candidate place category patterns.

The mobile user device may comprise a local database (typically stored on the memory of the mobile user device) storing positioning data for use by the positioning module of the mobile user device to estimate the location of the mobile user device.

It may be that some or all of one or more of the selected subsets of positioning data provided to the mobile user device are stored (e.g. temporarily) by the mobile user device in the local database.

It may be that the said customised user data comprises data derived from data aggregated from one or more social networks relating to the said user of the mobile user device and/or from internet browsing data (and/or an internet profile) of the said user of the mobile user device. It may be that the said data is indicative of one or more possible future activities of the said user of the mobile user device. For example, it may be that the said data is indicative of one or more possible future categories of activity, possible future categories of place or possible future geographical locations or geographical regions which the user of the device may perform, visit or occupy.

Typically the said data derived from data aggregated from one or more social networks relating to the said user of the mobile user device and/or from internet browsing data (and/or an internet profile) of the said user of the mobile user device comprises one or more parameters indicative of one or more possible future activities of the said user of the mobile user device. It may be that the said one or more parameters are indicative of one or more possible future activities of the said user of the mobile user device which do not follow a previous activity pattern of the said user of the mobile user device.

The said parameters indicative of one or more possible future activities of the said user of the mobile user device may comprise one or more natural language keywords, e.g. concerning a category or type of possible activity of the said user or a category or type of place which may be visited by the user.

The said data derived from data aggregated from one or more social networks relating to the said user of the mobile user device and/or from internet browsing data (and/or an internet profile) of the said user of the device may comprise one or more time references indicative of one or more times at which the said user of the mobile user device may (e.g. is expected or is likely to) occupy a geographical location or a geographical region in accordance with the said data.

It may be that the step of determining that one or more subsets of positioning data from the positioning data provided in the database meet one or more relevance criteria relating to the customised user data comprises determining (or the controller may be programmed to determine) that one or more subsets of positioning data from the positioning data provided in the database meet one or more relevance criteria relating to customised user data derived from data aggregated from one or more social networks relating to the said user of the mobile user device and/or from internet browsing data (and/or an internet profile) of the said user. In the event that the data derived from data aggregated from one or more social networks relating to the said user of the mobile user device and/or from internet browsing data (and/or an internet profile) of the said user comprises a said time reference, it may be that the determination that the said selected subsets of positioning data meet one or more relevance criteria relating to the said data is performed (or the controller may be programmed to determine that the said selected subsets of positioning data meet one or more relevance criteria relating to the said data) taking into account the time reference. For example, it may be that the method comprises determining (or the controller may be programmed to determine) that one or more subsets of positioning data from the positioning data provided in the database meet one or more relevance criteria relating to the said data at or in advance of a time indicated by the time reference. It may be that the method comprises selecting (or the selection module may be programmed to select) one or more subset(s) of positioning data from the database meeting one or more relevance criteria relating to the said data at or in advance of a time indicated by the time reference. It may be that the method comprises providing (or the data transfer module may be programmed to provide) the selected subsets of positioning data to the mobile user device at or in advance of a time indicated by the time reference.

It may be that the said data derived from data aggregated from one or more social networks relating to the said user of the mobile user device and/or from internet browsing data (and/or an internet profile) of the said user of the mobile user device comprises one or more natural language keywords concerning a category of possible activity of, or category of place which may be visited by, the said user of the mobile user device. It may be that the said data further comprises one or more time references associated with each of the said natural language keywords indicative of one or more times at which the user may (e.g. is expected or is likely to) perform that category of activity or visit that category of place.

The said data (e.g. one or more or each of the said parameters indicative of one or more possible future activities of the said user of the mobile user device) may comprise one or more metrics indicating a confidence level that the said user of the mobile user device will occupy a geographical region or geographical location in accordance with the said data. It may be that the said metrics indicate a confidence level that the said user of the mobile user device will occupy a location in accordance with the said data at one or more times indicated by a or the time reference associated with the said data. Alternatively, it may be that the metric associated with that data is adjusted in a first sense (e.g. increased) at or in advance of one or more times at which the user is expected to occupy a location in accordance with the said data, and/or adjusted in a second sense (e.g. decreased) different from the first sense at or in advance of one or more times at which the user is not expected to occupy a location in accordance with the said data. It may be that the method comprises determining one or more candidate possible future activities of the user from the said data, the said candidate possible future activities of the user having a confidence level metric which is greater than a predetermined threshold confidence level; and selecting one or more subset(s) of positioning data from the database meeting one or more relevance criteria relating to the said candidate possible future activities.

It will be understood that a social network is a network which allows users to create profiles for, and connect with, persons or businesses, to post messages, and to share said messages with profiles to which the user is connected (and/or to other users of the website). Social networks may also allow users to (e.g. manually) “check-in” with their current location and/or to manually enter further details about themselves or others to whom they are connected. Data entered by users to such networks may be time referenced.

It may be that the method comprises selecting (or the selection module is programmed to select) first and second subsets of positioning data from the database of positioning data responsive to a determination that the said selected subset(s) of positioning data meet one or more relevance criteria relating to the said customised user data (e.g. relevant to a said activity category pattern of the said user of the mobile user device). It may be that the first subset of positioning data is geo-referenced to a first discrete geographical region and the second subset of positioning data is geo-referenced to a second discrete geographical region different from the first discrete geographical region.

It may be that the method further comprises predicting (or the controller may be programmed to predict) one or more (preferably two or more, even more preferably three or more) candidate future geographical locations or candidate future geographical regions of the user of the mobile user device taking into account (e.g. from) the said customised user data (e.g. candidate future geographical locations or candidate future geographical regions being geographical locations or geographical regions which have been determined from the customised user data as being possible, likely or expected future geographical locations or geographical regions of the user of the mobile user device), wherein one or more (or each) of the subsets of positioning data selected from the database comprises positioning data referenced to a respective discrete geographical region comprising one or more of the said candidate future geographical locations or at least overlapping one or more of the said candidate future geographical regions.

It may be that the step of selecting the said subset of positioning data referenced to one of the said discrete geographical regions is performed (or the selection module may be programmed to select the said subset of positioning data referenced to one of the said discrete geographical regions) responsive to a determination that the discrete geographical region associated with the selected subset comprises one or more amenities meeting one or more relevance criteria relating to the said customised user data. More generally it may be that the step of selecting a said subset of positioning data is performed (or the selection module may be programmed to select a said subset of positioning data) responsive to a determination that a discrete geographical region to which the selected subset is geo-referenced comprises one or more amenities meeting one or more relevance criteria relating to the said customised user data

It may be that the said amenities are associated with an activity category or category of place which matches an activity category, activity category pattern, place category or place category pattern specified in the customised user data.

It may be that at least one of the selected subsets of positioning data provided to the mobile user device comprises positioning data referenced (e.g. in the database) to a discrete geographical location or region not comprising an estimated (e.g. current) location of the mobile user device.

It may be that the step of selecting one or more subsets of positioning data from the positioning data provided in the said database is performed (or the selection module may be programmed to select one or more subsets of positioning data from the positioning data provided in the said database) further taking into account an estimated (e.g. current) location of the mobile user device. For example, it may be that only positioning data relating to geographical locations or geographical regions within a predetermined radius of the (e.g. current) location of the mobile user device is considered for selection (by the selection module). The said radius may be fixed, or the said radius may be variable (e.g. depending on a determined mode of transport employed by the said user of the mobile user device).

It may be that the step of selecting one or more subsets of positioning data from the positioning data provided in the said database is performed (or the selection module may be programmed to select one or more subsets of positioning data from the positioning data provided in the said database) further taking into account time (e.g. a time reference indicated provided in the customised user data and/or a current time).

It may be that the positioning data in the database is associated with a metric indicative of a confidence level of the accuracy of the positioning data. The method may comprise storing (or the mobile user device may be programmed to store in its memory) positioning data on the mobile user device for a time period commensurate with the confidence level indicated by the metric associated with that data (i.e. the greater the confidence level indicated by the metric, the longer the time period for which the data associated with that metric is stored on the mobile user device).

The method may further comprise selecting (or the selection module may be configured to select) a first subset of positioning data from the positioning data provided in the said database (typically less than all of the positioning data provided in the said database) responsive to a determination that the said selected first subset of positioning data meets one or more relevance criteria relating to the said customised user data; and selecting (or the selection module may be configured to further select) one or more second subsets of positioning data from the positioning data provided in the said database, each of the said second subsets of positioning data being geo-referenced to a (discrete) geographical location or region provided between an estimated (current) location of the mobile user device and a (discrete) geographical location or region to which the first selected subset of positioning data is geo-referenced. The method typically further comprises providing (or the data transfer module is programmed to provide) the said selected first and second subsets of positioning data (which combined are typically less than all of the positioning data provided in the database) to the mobile user device.

The method may comprise selecting (or the selection module may be programmed to select) one or more subsets of positioning data relating to one or more possible future destination geographical locations or regions of the mobile user device inferred from the customised user data. The method may comprise selecting (or the selection module may be programmed to select) one or more subsets of positioning data relating to one or more geographical locations or regions provided between an estimated (current) position of the mobile user device and one or more possible destination geographical locations or regions of the mobile user device inferred from the customised user data.

The method may comprise selecting (or the selection module may be programmed to select) one or more subsets of positioning data relating to one or more geographical locations or regions provided between a first predicted (or possible) future location of the mobile user device and a second predicted (or possible) future location of the mobile user device subsequent to the first predicted (or possible) future location (e.g. the user may be a commuter between first and second train stations and the method may comprise selecting one or more subsets of positioning data relating to one or more geographical locations or regions provided between a “home” location of the user and the first train station, between the first and second train stations and/or between the second train station and a “work” location of the user).

It may be that the method comprises (or the controller may be programmed to perform the following steps): providing first customised user data specific to a user of a first mobile user device; selecting (or the selection module being programmed to select) one or more first subsets of positioning data from the positioning data provided in the said database (less than all of the positioning data provided in the said database) responsive to a determination that the said first subsets of positioning data meet one or more relevance criteria relating to the said first customised user data; providing (or the data transfer module being programmed to provide) the first selected subsets of positioning data to the first mobile user device; providing second customised user data specific to a user of a second mobile user device; selecting (or the selection module being programmed to select) one or more second subsets of positioning data from the positioning data provided in the said database (less than all of the positioning data provided in the said database) responsive to a determination that the said second subsets of positioning data meet one or more relevance criteria relating to the said second customised user data; and providing (or the data transfer module being programmed to provide) the second selected subsets of positioning data to the second mobile user device.

Typically the first customised user data is different from the second customised user data. Accordingly, typically the second subsets of positioning data are different from the first subsets of positioning data.

The method may further comprise: determining that the first and second mobile user devices occupy the same discrete geographical region; and providing one or more third subsets of positioning data relating to the said discrete geographical region, or to one or more geographical regions neighbouring the said discrete geographical region, to both the first and second mobile user devices.

The method may further comprise providing (or the data transfer module may be programmed to provide) location specific geographical descriptive data, (such as mapping data or geographical descriptive data relating to one or more geographical features, geographical spatial features, amenities, businesses or brands) to the mobile user device responsive to a determination that the said location specific geographical descriptive data meets one or more relevance criteria associated with the said customised user data. It may be that the selected location specific geographical descriptive data relates to a (discrete) geographical location or region to which a selected subset of positioning data is geo-referenced. Typically, the location specific geographical descriptive data is usable by (e.g. the positioning module of) the mobile user device to estimate (or to refine an estimate) of its location.

It may be that the location specific geographical descriptive data comprises location specific geographical descriptive data relating to a (discrete) geographical location or region provided between an estimated (current) location of the mobile user device and a (discrete) geographical location or region to which a selected subset of positioning data is geo-referenced (or between first and second predicted future locations of the user). The location specific geographical descriptive data may comprise one or more geographical routes (e.g. walking routes or routes relating to one or more other forms of transport) extending from a first location to a second location, at least one of the first and second locations (typically at least the second location, but optionally both the first and second locations) being provided in a discrete geographical region to which a selected subset of positioning data is geo-referenced. It may be that the other of the first and second locations (typically the first location) is an estimated (current) location of the mobile user device. It may be that the first location is provided in a first discrete geographical region to which a first selected subset of positioning data is geo-referenced and the second location is provided in a second discrete geographical region to which a second selected subset of positioning data is geo-referenced. It may be that the first location is a location which has never previously been occupied by the user. It may be that the first location and/or the second location is a possible future location of the mobile device inferred from the customised user data. It may be that a plurality of possible second locations are inferred from the customised user data, said location specific geographical descriptive data being provided which relates to each of the said plurality of possible second locations, and/or one or more geographical locations or regions provided between the said first location and each of the said possible second locations.

The method may comprise selecting (or the selection module may be programmed to select) one or more subsets of positioning data relating to one or more geographical locations or regions provided along a route extending between an estimated (current) position of the mobile user device and one or more possible destination geographical locations or regions of the mobile user device inferred from the customised user data, the said route being provided by the said selected geographical descriptive data. The method may further comprise adjusting (or the mobile user device may be programmed to adjust) an estimated location of the mobile user device taking into account the selected geographical descriptive data, e.g. to better match the geographical descriptive data.

It may be that a discrete geographical region to which positioning data of the positioning database is geo-referenced comprises an indoor region. It may be that the location specific geographical descriptive data comprises geographical descriptive data relating to the said indoor region. The said geographical descriptive data may comprise navigation data for assisting the mobile user device to estimate its position within the indoor region. For example, the geographical descriptive data may comprise a reference location of each of one or more geographical spatial features such as doors, corridors, turning points, floor change points or regions, staircases, elevators, escalators etc which can be used by the mobile user device to adjust its estimated location, e.g. to better match the geographical descriptive data. The geographical descriptive data may further comprise one or more paths or routes along which the user can travel within the said indoor region. The geographical descriptive data may comprise the location of each of one or more reference points within the indoor region.

It may be that the method further comprises storing (or the mobile user device is programmed to store) data from (or data derived from) the selected subsets of positioning data on a (or the) memory of the mobile user device.

Typically, the said customised user data is comprised in a user profile associated with the said user of the mobile user device. The step of providing the customised user data may comprise retrieving (or the data transfer module may be programmed to retrieve) the customised user data from the user profile. The user profile may be stored in a user profile database (typically stored on the controller, e.g. one or more servers of the controller). The user profile database may comprise a plurality of user profiles, each of the user profiles being associated with an identifier of a user of a mobile user device (and/or an identifier of the mobile user device).

It may be that the positioning data stored in the said database (and typically the selected subsets of positioning data provided to the mobile user device) comprises data concerning a plurality of radio frequency electromagnetic signal sources (e.g. terrestrial radio frequency electromagnetic signal sources such as Wi-Fi access points, Bluetooth beacons or the like) and/or (radio frequency electromagnetic) signals from radio frequency electromagnetic signal sources.

It may be that the positioning data stored in the database (and typically the selected subsets of positioning data provided to the mobile user device) comprises identifiers (e.g. MAC addresses) and (e.g. estimated) positions (e.g. 2D or 3D coordinates, for example latitude, longitude and optionally altitude) of each of a plurality of radio frequency electromagnetic signal sources (such as wireless access points). The positioning data may comprise a type of radio frequency electromagnetic signal source.

It may be that the positioning data stored in the database (and typically the selected subsets of positioning data provided to the mobile user device) comprises transmitted signal powers from each of a plurality of the said radio frequency electromagnetic signal sources. Alternatively, it may be that the transmitted signal powers from each of a plurality of the said radio frequency electromagnetic signal sources can be obtained by the mobile user device from signals transmitted by the said radio frequency electromagnetic signal sources.

It may be that the positioning data stored in the database (and typically the selected subsets of positioning data provided to the mobile user device) comprises radio frequency electromagnetic signal source (“fingerprint”) data relating to (expected radio frequency electromagnetic) signal strengths detectable from each of one or more radio frequency electromagnetic signal sources at each of a plurality of positions (e.g. 2D or 3D coordinates, for example latitude, longitude and optionally altitude). A mobile user device can estimate its position from such “fingerprint” data by measuring the signals (typically measurements of the strength of radio frequency electromagnetic signals) from radio frequency electromagnetic signal sources, comparing these with the fingerprint data and estimating its positing as the geographical location of the most closely matching fingerprint data, or more typically using interpolation to compute a position intermediate the geographical location of stored fingerprint data. In a related strategy, the positioning data comprises parameters of a function which describes the (expected) spatial variation in the strength of signals from a plurality of radio frequency electromagnetic signal sources and the mobile user device processes this data to determine the location that best fits the measured strength of radio frequency signals from radio frequency electromagnetic signal sources. The positioning data may concern both the geographical locations of the said radio frequency electromagnetic signal sources and the geographical location of (expected) signal strengths from the said radio frequency electromagnetic signal sources.

It may be that the fingerprint data was originally measured by one or more sensors provided on the said mobile user device (or by sensors on another mobile user device) and stored in the database.

It may be that the method comprises the mobile user device receiving and storing (or the mobile user device is programmed to receive and store) positioning data concerning a geographical region on the mobile user device; subsequently (e.g. periodically) carrying out (or the mobile user device or the controller is programmed to carry out) a data validation procedure to determine whether to update the said positioning data and, if it is determined that the said positioning data should be updated, receiving (or the mobile user device is programmed to receive) updated positioning data relevant to the said geographical region (e.g. from the controller) and updating (or the mobile user device is programmed to update) the stored positioning data using the updated positioning data. It may be that the method further comprises (e.g. the mobile user device) requesting (or the mobile user device is programmed to request) updated positioning data relevant to the said geographical region (e.g. from the controller). It may be that the method comprises (e.g. the mobile user device) accepting (or the mobile user device is programmed to accept) updated positioning data relevant to the said geographical region (e.g. from the controller).

It may be that the method comprises: receiving and storing (or the mobile user device is programmed to receive and store) positioning data concerning a geographical region; selecting (or the selection module may be programmed to select) one or more subsets of positioning data from the positioning data provided in the said database responsive to a determination that the said subsets of positioning data meet one or more relevance criteria relating to the said customised user data; and subsequently carrying out (e.g. the mobile user device or the controller is programmed to carry out) a data validation procedure to determine whether to update the stored positioning data in accordance with the selected subset(s) of positioning data. The method may further comprise (e.g. the controller) sending an initial message (typically not comprising the selected subsets of positioning data) to the mobile user device to identify the selected subsets of positioning data (typically including data identifying one or more geographical locations or geographical regions associated with the selected subsets) prior to carrying out the data validation procedure. The data validation procedure may be performed responsive to receipt of the said initial message. The method may further comprise: determining whether the said stored positioning data should be updated. It may be that, if it is determined by the data validation procedure that the said stored positioning data should be updated, the method comprises (e.g. the mobile user device) requesting that the selected subset(s) of positioning data be sent to the mobile user device. The method may further comprise providing the selected subset(s) of positioning data to the mobile user device. The method may further comprise receiving (or the mobile user device is programmed to receive) the said selected subset(s) of positioning data (e.g. from the controller); and updating (or the mobile user device is programmed to update) the stored positioning data using the received selected subset(s) of positioning data. It may be that the selected subset(s) of positioning data comprise positioning data concerning the said geographical region.

It may be that the method comprises initially selecting (or the selection module may be programmed to initially select) one or more subsets of positioning data from the positioning data provided in the said database responsive to a determination that the said subsets of positioning data meet one or more relevance criteria relating to the said customised user data; and subsequently carrying out (e.g. the mobile user device or the controller is programmed to carry out) a data validation procedure to determine whether to update the stored positioning data in accordance with the initially selected subset(s) of positioning data. The method may further comprise (e.g. the controller) sending an initial message (typically not comprising the selected subsets of positioning data) to the mobile user device to identify the initially selected subsets of positioning data (typically including data identifying one or more geographical locations or geographical regions associated with the initially selected subsets) prior to carrying out the data validation procedure. The data validation procedure may be performed responsive to receipt of the said initial message. The method may further comprise determining whether the said stored positioning data should be updated. It may be that, if it is determined by the data validation procedure that the said stored positioning data should be updated, the method comprises: (e.g. the mobile user device) requesting updated positioning data; and (typically the controller, typically responsive to the request for updated positioning data, e.g. using data provided in the request for updated positioning data) selecting one or more (or all of the) subsets of positioning data from the initially selected subset(s) of positioning data and (the data transfer module) providing them to the mobile user device.

Accordingly, the mobile user device can regulate the amount of positioning data which it receives, with the aim of meeting (potentially varying) standards for the quality of position estimates, while minimising unnecessary data transfer and associated unnecessary bandwidth and power consumption requirements.

The data validation procedure typically comprises analysing the positioning data stored on the mobile device relating to a geographical region to determine whether to update the stored positioning data relating to that geographical region. The geographical region may be a predefined discrete geographical region, or the geographical region may simply be determined when required, for example to define the positioning data which is to be subject to the data validation procedure or to define the requested or received updated positioning data. Thus the method may comprise selecting or defining (or the mobile user device may be programmed to select or define) the said geographical region. The request for updated positioning data may comprise a reference to the geographical region (for example an identifier of a geographical region, or a reference to a geographical location which is within a geographical region).

The geographical region which is subject to the validation procedure and/or the geographical region to which the requested updated positioning data and/or received updated positioning data relate, and the geographical region of the stored positioning data which is updated may be different, although relevant to the geographical region for which the data validation procedure relates. For example, it may be that the validation procedure is applied to a first geographical region which currently surrounds the mobile user device (e.g. a circle of defined radius, or rectangle of defined length and breadth), but a request is made for updated positioning data concerning a second geographical region (e.g. a grid square or other predefined area or volume) which is part of, overlaps with, or includes the first geographical region. This may, for example, occur because the validation procedure determines that only part of the first geographical region requires an update or because updates relate to predefined geographical regions and the first geographical region is not identical to any of the predefined geographical regions. The mobile user device may then receive updated positioning data concerning a third geographical region which is part of, overlaps with, includes or is adjacent to the second geographical region. This may occur because the controller which receives the request and responds with the updated positioning data will take into account its knowledge of what updated positioning data is available and to what extent updated positioning data may assist the mobile user device. For example, the controller may be aware of substantial changes to positioning data concerning a geographical region which is proximate to the first or second geographical region and to transmit updated positioning data concerning that adjacent geographical region in addition to or instead of updated positioning data concerning the first or second geographical region.

It may be that the received selected subset(s) of positioning data comprises updates to the stored positioning data and the step of updating the positioning data does not replace all of the stored positioning data relating to the said geographical region. By receiving updates and updating positioning data, the total amount of data received may be minimised, reducing power consumption.

The step of updating the stored positioning data may for example comprise one or more of (or the mobile user device may be programmed to perform one or more of the following steps): storing positioning data concerning one or more electromagnetic signal sources about which data was not previously stored, amending positioning data concerning one or more electromagnetic signal sources (for example, amending the estimated location of one or more electromagnetic signal sources), or removing data concerning one or more electromagnetic signal sources from the stored positioning data.

It may be that the data validation procedure takes into account a time associated with the stored positioning data. The time associated with the positioning data may for example be one or more of: the time at which the positioning data was received by the mobile user device, the time at which the positioning data was transmitted by a remote server (e.g. a server of the controller), the time at which the positioning data was updated by the mobile user device, or the time at which the positioning data was updated by a remote server (e.g. a server of the controller). The time associated with the stored positioning data may be a time associated with the stored positioning data concerning the said geographical region, or part thereof.

It may be that the data validation procedure takes into account a parameter associated with the maturity, level of confidence, consistency, or expected rate of change of the stored positioning data relating to the geographical region, of part thereof. The parameter may have a numerical value, with a higher or lower value being associated with greater maturity, level of confidence or expected rate of change of the positioning data. However, the parameter may for example be a flag or label, or any other datum. The parameter may be received with the positioning data, or updates to the positioning data. The parameter may be computed by the mobile user device.

Positioning data may be considered to be more mature if it has been generated from more measurements and/or from measurements of signals from more electromagnetic signal sources and/or if the improvement to the accuracy of the data which arises from receiving additional relevant observation data is lower. The expected rate of change of the positioning data may be determined taking into account a previous rate of change of the positioning data, for example, the rate at which electromagnetic signal sources are discovered, or disappear, or move. The level of confidence of the positioning data is typically related to the level of confidence of the location of a mobile user device which can be determined using the positioning data.

Data may be selected depending, for example, on a parameter associated with the accuracy, quality, maturity, consistency, a time associated with the data, or the age of the data. Data may be not selected responsive to determining that it is inconsistent.

It may be that positioning data is selected or deselected responsive to measurements by the mobile user device of signals from electromagnetic signal sources which the positioning data concerns.

The controller typically receives the request for updated positioning data (from the mobile user device) and transmits the selected subset(s) of positioning data to the mobile user device (typically responsive to the said request). The controller may determine whether to transmit one or more selected subsets of positioning data (or one or more portions thereof) from one or more initially selected subset(s) of positioning data to the mobile user device. The controller may determine when to transmit the selected subset(s) of positioning data to the mobile user device. The controller may determine which of the initially selected subset(s) of positioning data to send, for example the controller may determine which geographical region and/or which electromagnetic signal sources the selected subset(s) of positioning data should relate to.

It may be that the mobile user device transmits property data concerning one or more properties of stored positioning data relevant to the geographical region, to a or the controller.

The controller may determine from one or more said properties which of the initially selected subset(s) of positioning data to send to the mobile user device. The controller may determine whether to transmit one or more selected subsets of positioning data (or one or more portions thereof) from one or more initially selected subset(s) of positioning data to the mobile user device taking into account the said one or more properties. The controller may determine from one or more said properties which of the initially selected subset(s) of positioning data (e.g. in respect of which electromagnetic signal sources) to include in the selected subset(s) of positioning data sent to the mobile user device. The said determination may comprise comparing one or more said properties with a predetermined threshold. The determination may comprise comparing one or more said properties with a corresponding property of corresponding positioning data stored in the (e.g. controller or server) database of positioning data. The determination may comprise comparing one or more said properties with a corresponding property, sent by the mobile user device, of corresponding positioning data stored in the mobile user device (in the mobile user device local database of positioning data).

The property data may be a metric related to the quality of the stored positioning data relevant to position, for example, it may comprise one or more of the accuracy, maturity, consistency, or the age of the positioning data relevant to the geographical region, or a time associated with the positioning data relevant to the geographical region.

The mobile user device may transmit importance data concerning the relative importance of receiving updated positioning data, to the controller. The said importance data may be used by the controller to prioritise the sending of updates to the mobile user device.

The mobile user device may transmit requirement data indicative of a specific requirement of the mobile user device for positioning data to the controller. Requirement data may for example indicate to the controller that relatively more data is required in order to facilitate especially accurate location measurements.

It may be that the method comprises collecting (or the controller and/or mobile device comprises an aggregator module programmed to collect) data from one or more social networks relating to the said user of the mobile user device and/or internet browsing data and/or data from one or more web profiles of the said user of the mobile user device. The method may comprise generating (or the controller may further comprise a parameter generation module programmed to generate) one or more parameters indicative of one or more possible future activities or geographical locations or regions of the user from the collected data.

The method may further comprise generating (or the controller may comprise a parameter generation module programmed to generate) one or more parameters indicative of one or more possible future activities (or possible future locations or regions) of the said user of the mobile user device from one or more patterns in the data aggregated from one or more social networks relating to the said user of the mobile user device and/or from internet browsing data (and/or an internet profile) of the said user of the mobile user device. Patterns may be recognised by a pattern recognition module of the controller. The method may comprise sorting (or the controller may comprise a sorting module programmed to sort), e.g. chronologically, the data aggregated from one or more social networks relating to the said user of the mobile user device and/or from internet browsing data (and/or an internet profile) of the said user of the mobile user device (e.g. in a chronological order), typically prior to generating one or more parameters (typically from the sorted data).

The data aggregated from one or more social networks relating to the said user of the mobile user device and/or from internet browsing data (and/or an internet profile) of the said user of the mobile user device may comprise, for example but not exclusively, one or more, or two or more, or three or more, selected from the following list: data from one or more social networking websites (e.g. blog posts, check-in location data, time reference data), data from one or more search engines (e.g. search terms), web browser data, message data (typically subject to permissions set by a user of the device), data relating to requests for positioning data.

The method may comprise comparing (or the controller may be programmed to compare) said aggregated data with keywords provided in a keywords database. The method may further comprise recognising (or the controller may be programmed to recognise) matches between said aggregated data and keywords from the keywords database and adding the matching keywords (permanently or, more typically, temporarily) to the customised user data.

The step of generating one or more parameters indicative of one or more possible future activities (or one or more possible future locations or regions) of the said user of the mobile user device may comprise receiving (or the parameter generation module may be programmed to receive) one or more said parameters from a manual user input.

It may be that the method further comprises (or the controller is programmed to perform the following steps): monitoring one or more activities (e.g. one or more locations) of the said user of the mobile user device (e.g. the controller being programmed to receive updated estimates of the location of the mobile user device so as to track movements of the device); and generating (or a or the parameter generation module of the controller being programmed to generate) customised user data specific to the said user of the device relating to said monitored activities. The method may further comprise storing (or the controller may be further programmed to store) the generated customised user specific data (e.g. on the memory of the controller).

It may be that the step of monitoring one or more activities of the user comprises tracking (or the controller may be programmed to track) a geographical location or geographical region of the user (which is typically inferred from a geographical location or geographical region of the mobile user device), the method further comprising calculating (or the controller being programmed to calculate) one or more metrics, each of the said metrics being geo-referenced to a geographical location and/or one or more geographical regions which has been occupied by the said user of the mobile user device and providing an indication of the probability that the said user of the mobile user device will occupy the geographical location or geographical region geo-referenced to that metric. The method may comprise storing (or the controller may be programmed to store) said metrics (e.g. as customised user data, e.g. in the said memory of the controller).

It may be that the step of monitoring one or more activities of the user comprises tracking (or the controller may be programmed to track) a geographical location or geographical region of the user (which is typically inferred from a geographical location or geographical region of the mobile user device), the method further comprising determining (or the controller being programmed to determine) from the tracked geographical location or geographical region one or more categories of place relating to the tracked geographical location or geographical region (or one or more categories of place visited by the said user of the mobile user device). The method may further comprise storing (or the controller may be programmed to store) the said categories of place, and typically associating the said categories of place with the tracked geographical location or geographical region to which it relates (e.g. as customised user data, e.g. in the memory of the controller). The method may comprise comparing (or the controller may be programmed to compare) the said two or more tracked geographical locations or geographical regions of the said user of the mobile user device to mapping data (which may be obtained from a third party mapping application such as Google Places or other location specific residential, business or retail directories) to determine the said one or more categories of place visited by the user (e.g. a location of the said user corresponding to a location of a geographical feature, business or brand may be categorised into a category of place associated with that geographical feature, business or brand).

It may be that the step of monitoring one or more activities of the user comprises tracking (or the controller may be programmed to track) a geographical location or geographical region of the user (which is typically inferred from a geographical location or geographical region of the mobile user device), the method further comprising determining (or the controller being programmed to determine) from the tracked geographical location or geographical region of the mobile user device one or more activity patterns of the said user of the mobile user device. The method typically comprises storing (or the controller may be programmed to store) data concerning the said one or more activity patterns of the said user of the mobile user device (e.g. as customised user data, e.g. in the memory of the controller).

The method may comprise generating (or the parameter generation module may be programmed to generate) one or more natural language keywords representing an activity pattern of the said user of the mobile user device. The method may comprise generating (or the parameter generation module may be programmed to generate) one or more natural language keywords representing an activity pattern of the said user of the mobile user device taking into account a time reference indicative of a time at which the device is likely to act in accordance with the said activity pattern. Typically the method comprises storing (or the controller is programmed to store) said natural language keywords (e.g. as customised user data, e.g. in the memory of the controller).

The method may comprise associating (or the controller may be programmed to associate) one or more categories of place with each of two or more geographical locations or geographical regions which have been occupied by the said user of the mobile user device. The method may further comprise comparing the categories of place associated with each of two or more of the said tracked geographical locations or geographical regions to identify categories of place in common between the said two or more geographical locations or geographical regions of the said user of the mobile user device. The method may further comprise generating (or the parameter generation module may be programmed to generate) data (e.g. one or more natural language keywords) representing one or more place category patterns of the said user of the mobile user device from the said categories of place in common (and optionally from time references associated with the said geographical locations or geographical regions). The method typically comprises storing said generated natural language keywords (e.g. as customised user data, e.g. on the memory of the controller).

The method may comprise generating (or the parameter generation module may be programmed to generate) one or more natural language keywords representing a category of place occupied by the said user of the mobile user device. The method may comprise generating (or the parameter generation module may be programmed to generate) one or more natural language keywords representing a category of place occupied by the said user of the mobile user device taking into account a time reference indicative of a time at which the device is likely to visit a geographical location or geographical region relating to (e.g. comprising) the said category of place. Typically the said natural language keywords are stored in the customised user data. The method typically comprises storing said generated natural language keywords (e.g. as customised user data, e.g. on the memory of the controller).

The method may comprise associating (or the controller may be programmed to associated) one or more activity categories with each of two or more geographical locations or geographical regions which have been occupied by the said user of the mobile user device. The method may comprise comparing (or the controller may be programmed to compare) the said two or more tracked geographical locations or geographical regions of the said user of the mobile user device to mapping data (which may be obtained, and/or from other data which may be obtained, from a third party mapping application such as Google Places or other location specific residential, business or retail directories) to determine one or more activity categories to associate with the said geographical locations or geographical regions (e.g. a location of the said user corresponding to a location of a geographical feature, business or brand may be categorised into an activity category associated with that geographical feature, business or brand).

The method may comprise generating (or the parameter generation module may be programmed to generate) one or more natural language keywords representing a category of activity performed or performable by the said user of the mobile user device. The method may comprise generating (or the parameter generation module may be programmed to generate) one or more natural language keywords representing a category of activity performed or performable by the said user of the mobile user device taking into account a time reference indicative of a time at which the device is likely to visit a geographical location or geographical region relating to (e.g. comprising) the said category of activity. The method typically comprises storing said generated natural language keywords (e.g. as customised user data, e.g. on the memory of the controller).

The method may further comprise comparing the activity categories associated with each of two or more of the said geographical locations or geographical regions to identify activity categories in common between the said two or more geographical locations or geographical regions of the said user of the mobile user device. The method may further comprise generating (or the parameter generation module may be programmed to generate) data (e.g. one or more natural language keywords) representing one or more activity category patterns of the said user of the mobile user device from the said activity categories in common (and optionally from time references associated with the said geographical locations or geographical regions). The method typically comprises storing data concerning the said one or more activity category patterns of the said user of the mobile user device (e.g. as customised user data, e.g. in the memory of the controller).

By recognising activity or place categories in common between two or more geographical locations or geographical regions which have been occupied by the said user of the mobile user device, activity patterns of the said user can be identified even if there is no identifiable pattern in the movements of the user alone.

It may be that the geographical locations or geographical regions occupied by the user are analysed retrospectively to provide/update the customised user data. For example, the geographical locations or geographical regions occupied by the user may be analysed retrospectively to determine/update the said metrics, categories of place, activity categories, activity patterns, patterns of movement, activity category patterns and so on.

The method may comprise dynamically updating (or the controller may be programmed to dynamically update) the customised user data, typically responsive to one or more of the following: a current time; an estimated location of the mobile user device; or data aggregated from one or more social networks and/or internet browsing data of the user or data derived therefrom. Dynamically updating the customised user data may comprise temporary customised user data being removed over time and/or temporary or permanent customised user data being added over time. In this way, it can be ensured that the customised user data is kept relevant and up to date. In addition, it may be that customised user data is relevant at one or more times (and/or at one or more geographical locations or geographical regions), but not at others. It may be that the customised user data is dynamically updated to include customised user data relevant to the said user of the mobile user device at a given time (and/or a given geographical location or geographical region). For example, the given time may be specified in the customised user data, or elsewhere (e.g. on one or more servers of the controller). The method may further comprise selecting (or the selection module may be programmed to select) one or more subsets of positioning data from the positioning data provided in the said database responsive to a determination that the said subsets of positioning data meet one or more relevance criteria relating to the said dynamically updated customised user data; and providing the selected subsets of positioning data to the mobile user device.

It will be understood that, although the term “user of the mobile user device” used in this specification is typically referring to an individual (human) user, it may be that the “user” is a generic user account used by more than one individual (human) user.

By a database we refer to data retrievably stored on a tangible data storage device in an organised format from which selected data can be retrieved, and no limitation is intended to any specific format of database (e.g. hierarchical, relational, object, XML, graph).

The mobile user device may comprise a portable electronic device, such as a laptop, mobile smartphone, tablet, phablet or wearable electronic device, e.g. smart watch. The mobile user device may comprise a plurality of separate or separable components which are in (typically direct) wired or wireless communication with each other (e.g. a mobile telephone, tablet or computer and a separate or separable wearable component). One or more of the separate or separable components may be wearable components, for example a watch, glasses, or contact lenses. The stored positioning data may be distributed between more than one said component, or replicated in part in more the one said component.

A third aspect of the invention provides a system comprising: a plurality of mobile user devices, each of the said mobile user devices comprising a positioning module for estimating a location of the mobile user device and a memory for storing positioning data; and a controller comprising: a database storing positioning data for use by the positioning modules of the mobile user devices to estimate their positions; a memory storing customised user data specific to users of each of the mobile user devices; a selection module programmed to select one or more subsets of positioning data from the positioning data provided in the said database (typically less than all of the positioning data provided in the said database) relating to each of the said mobile user devices responsive to a determination that the said subsets of positioning data meet one or more relevance criteria relating to the said customised user data specific to the users of those devices; and a data transfer module programmed to provide the respective selected subsets of positioning data to the respective mobile user devices. The system may include any of the features discussed above in respect of the first or second aspects of the invention.

A fourth aspect of the invention provides a method of generating customised user data specific to a user of a mobile user device, the method comprising: monitoring one or more activities of the said user of the mobile user device; and generating customised user data specific to the said user of the device relating to said monitored activities. The method may include any of the steps discussed above in respect of the first, second or third aspects of the invention.

A fifth aspect of the invention provides data processing apparatus for generating customised user data specific to a user of a mobile user device, the data processing apparatus comprising: a monitoring module programmed to monitor one or more activities of the said user of the mobile user device; and a customised user data generation module programmed to generate customised user data specific to the said user of the device relating to said monitored activities. The data processing apparatus may include any of the features discussed above in respect of the first, second, third or fourth aspects of the invention.

A sixth aspect of the invention provides a non-transitory computer readable medium retrievably storing computer readable code for causing one or more computers to perform the steps of the method according to the first or fourth aspects of the invention or to operate as the controller according to the second aspect of the invention or to operate as the data processing apparatus of the fifth aspect of the invention.

Optional or essential features described above in respect of any one of the various aspects of the invention are at least optional features of any of the aspects of the invention.

### DESCRIPTION OF THE DRAWINGS

An example embodiment of the present invention will now be illustrated with reference to the following Figures in which:

FIG. 1 is a block diagram of a plurality of mobile user devices in data communication with a controller;

FIG. 2 is a more detailed block diagram of a mobile user device of FIG. 1;

FIG. 3 is a more detailed block diagram of a portion of the customised user data of FIG. 1, together with other features of the controller;

FIG. 4 is a more detailed block diagram of the controller and mobile user device of FIG. 1;

FIG. 5 is a more detailed block diagram of an additional or alternative portion of the customised user data of FIG. 1, together with other features of the controller;

FIG. 6 is a block diagram illustrating the data structure of the positioning data stored in the local database provided on the mobile user device;

FIG. 7 is a flow diagram of a data validation procedure; and

FIG. 8 illustrates an alternative mobile user device comprising a mobile telephone in wireless communication with a wearable component.

### DETAILED DESCRIPTION OF AN EXAMPLE EMBODIMENT

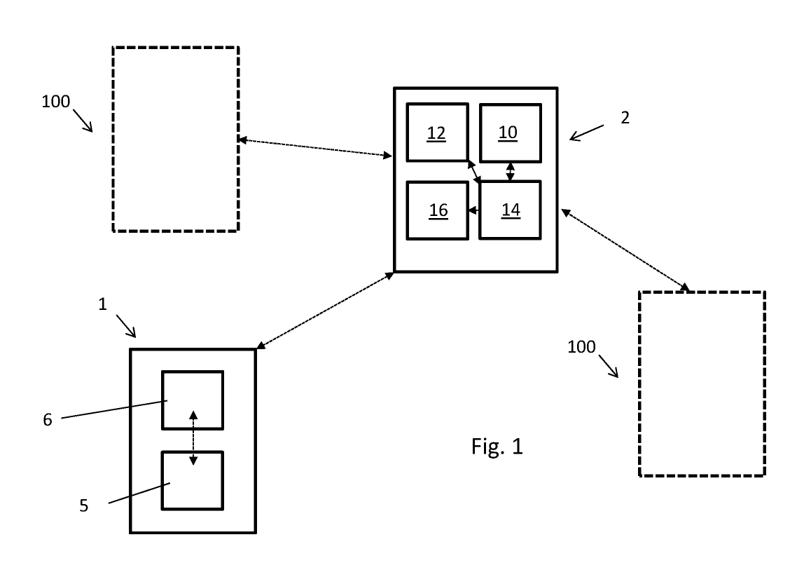

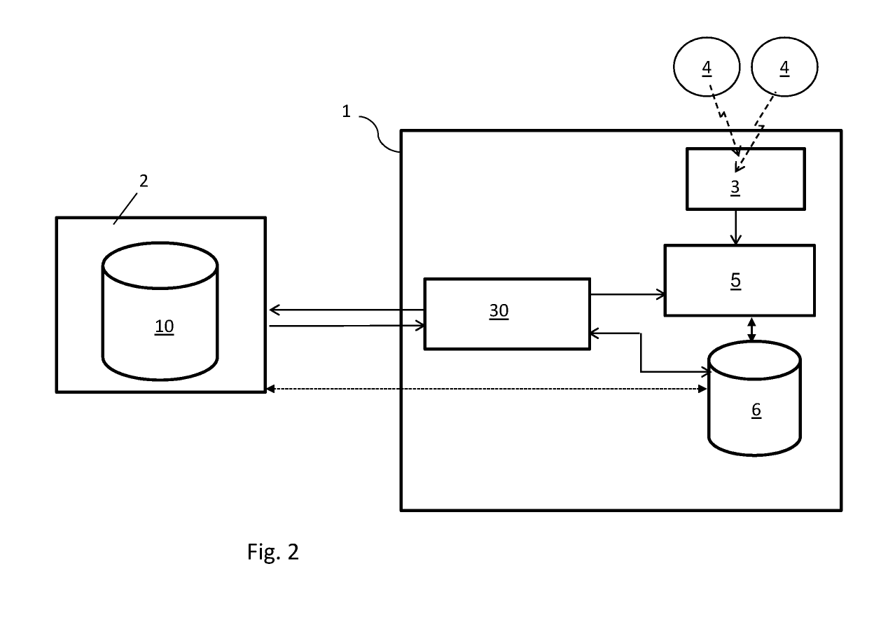

FIG. 1 is a schematic diagram of a mobile user device 1 (such as a mobile smartphone or tablet computer) in data communication (e.g. over a 2G, 2.5G, 3G or 4G cellular telephone network, or over the internet via for example a Wi-Fi connection) with a controller 2 provided on a server remote from the mobile user device 1 (although it will be understood that in some embodiments part of the controller 2 may be implemented on the mobile user device 1). The mobile user device 1, which is shown in more detail in FIG. 2, comprises a radio receiver 3 which receives signals from a plurality of radio frequency electromagnetic signal sources 4 and measures the strength of radio frequency signal received from the said sources 4. The mobile user device 1 further comprises a positioning module 5 for estimating the location of the device 1 by processing measurements from the radio receiver 3 together with reference data concerning this electromagnetic signal strength, the reference data being obtained from a local database 6 which is in (typically wired) data communication with the positioning module 5. The positioning module 5 calculates estimates of the location of the mobile user device 1 by calculating the distance of the mobile user device 1 from each of the radio frequency electromagnetic signal sources 4 using the following formula:

$${P}_{r} = \frac{{P}_{t} {G}_{t} {G}_{r} {λ}^{2}}{{( 4 n )}^{2} {d}^{2}} \qquad ( 1 )$$

where Pᵣ is the received signal power at the user device, Pₜ is the transmitted power of the electromagnetic signal source, G_{f} and Gₜ are the receiver and transmitter gains respectively, λ is the signal wavelength and d is a distance between source and receiver.

This function may alternatively be expressed in terms of propagation gain (PG) as:

$$PG = \frac{{P}_{r}}{{P}_{t} {G}_{t} {G}_{r}} = \frac{{λ}^{2}}{{( 4 n )}^{2} {d}^{2}} \qquad ( 2 )$$

and in decibels form as:

PG_{dB}=20 log(λ/4nd) (3)

Typically, all of the parameters of the above equations, apart from distance, d, are known to the mobile user device 1 either from the data measured from the electromagnetic signal sources 4 or from the locally stored positioning data from the local database 6. Accordingly, the mobile user device 1 may determine its distance, d, from a given electromagnetic signal source using the above equation.

The above equation is useful for a free space environment, but may not be sufficiently accurate for use in “real world” indoor environments such as tunnels or shopping centres. An alternative equation for use in such indoor environments may be:

PG_{dB}=20 log(λ/4nd₀)+10n log(d/d₀)X_{σ} (4)

where X, n and d₀ are parameters which vary with different indoor environments and which can be determined empirically.

By processing the known positions of radio frequency electromagnetic signal sources together with the distances calculated from each radio frequency electromagnetic signal source, the location of the mobile user device can be estimated by, for example, triangulation.

The controller 2 maintains a server database 10 (provided on the remote server) of positioning data concerning radio frequency electromagnetic signal sources 4 covering a wide geographic area (e.g. a town, a country, continent or the world). The local database 6 of the mobile user device 1 stores positioning data relating to a portion of this wide geographic area. The positioning data on both the server database 10 and the local database 6 comprises identifiers of stationary electromagnetic signal sources 4, an estimate of their location (e.g. latitude, longitude and optionally altitude or x, y and optionally z coordinates of a suitable reference frame), and parameters associated with their signal strength (e.g. a numerical value indicative of signal strength or a reference to the type of electromagnetic signal source 4, from which signal strength can be deduced), as well as other relevant data, such as how long the electromagnetic signal source 4 has remained at its current location, how frequently the electromagnetic signal source 4 has been detected, a level of confidence that the electromagnetic signal source 4 is a stationary electromagnetic signal source etc.

The positioning module 5 is programmed to request positioning data from the local database 6 in order to estimate the location of the mobile user device 1. However, the mobile user device 1 may change location and indeed may fall out of range of the electromagnetic signal sources 4 which are the subject of the positioning data stored in the local database 6. Thus when the mobile user device 1 (e.g. when a user of the mobile user device carrying the mobile user device 1) moves, it may be that the positioning data stored in the local database 6 is no longer relevant for use by the positioning module 5 to estimate the location of the device 1. Accordingly, the positioning data stored in the local database 6 needs to be updated over time.

It is desirable for the local database 6 to store only the positioning data that is required by the mobile user device 1 to estimate its location so as to minimise storage requirements of the local database 6. However, it is also desirable for positioning data to be transferred from the server database 10 to the local database 6 in the fewest number of data transfer events possible so as to reduce the power consumption of the mobile user device 1, and for the mobile user device 1 to be able to estimate its location at all times without a break in service.

In order to address these competing requirements, the controller 2 maintains a user profile database 12 comprising customised user data specific to a user of the mobile user device 1 (and typically customised user data specific to users of other mobile user devices, typically organised by user). The controller 2 further comprises a selection module 14 programmed to select one or more subsets of positioning data from the positioning data provided in the server database 10 (typically less than all of the positioning data provided in the server database 10) which may be relevant to the user based on the customised user data and a data transfer module 16 which provides (e.g. responsive to a request from the mobile user device 1 or “pushes”) the selected subsets of positioning data to the local database 6 of the mobile user device 1 when it is expected to be required by the positioning module 5 to estimate the location of the mobile user device 1 (or, more preferably, in advance of when it is expected to be required by the positioning module 5 to estimate the location of the mobile user device 1).

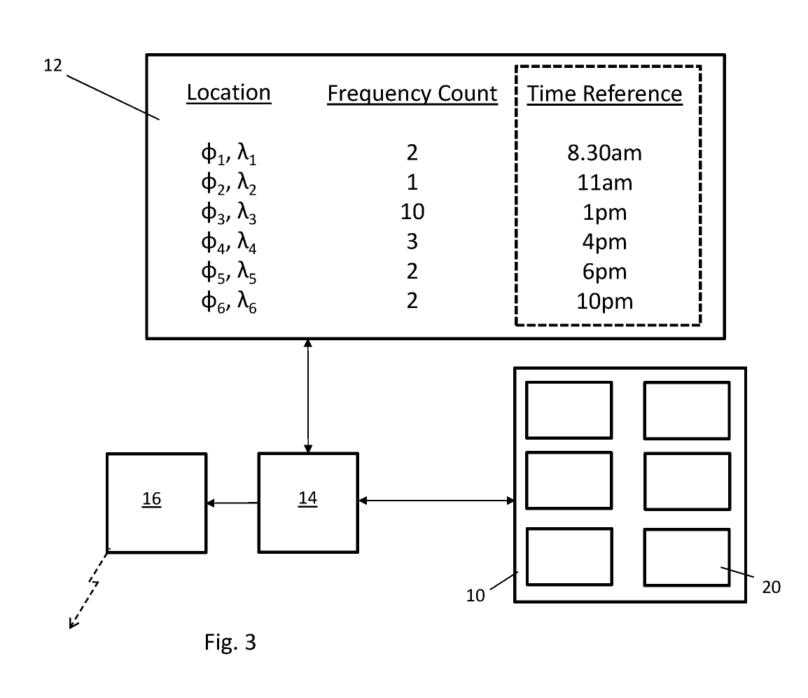

FIG. 3 shows a subsection of the customised user data 12 specific to the user of the mobile user device 1, the customised user data 12 comprising data identifying a plurality of geographical locations or geographical regions (illustrated by latitude, longitude co-ordinates in FIG. 3, but may optionally include an altitude, and may alternatively comprise a range of co-ordinates or a single co-ordinate and a defined radius around that co-ordinate for example to identify a geographical region) previously occupied by the user of the mobile user device 1. In each case, the data identifying the geographical location or geographical region previously occupied by the user is associated with a frequency count (or other metric) indicating a number of times the user has occupied that location or region (or, more specifically, a number of times the user has been determined to have occupied that location or region by the controller 2). This data may be generated by the controller 2, which receives periodic updates of the estimated location of the mobile user device 1, typically from the said mobile user device 1 itself.

FIG. 3 also illustrates a portion of the server database 10 in more detail. More specifically, the positioning data of the server database 10 is organised into a plurality of discrete subsets 20 of positioning data, each of the discrete subsets 20 being geo-referenced to a respective (different) geographical region. The geographical regions associated with the subsets 20 of positioning data may each be of different shapes and sizes or alternatively they may be of a uniform shape and size.

The selection module 14 is programmed to select one or more subsets 20 of positioning data from the server database 10 (typically significantly less than all of the positioning data stored in the server database 10) based on the customised user data 12 and the data transfer module 16 is programmed to provide the selected subsets 20 of positioning data to the local database 6 of the mobile user device 1. For example, the selection module 14 may be programmed to compare the frequency counts of the customised user data 12 with a predetermined threshold frequency count, and to select one or more subsets 20 of positioning data comprising the geographical locations or geographical regions, or at least overlapping the geographical regions, associated with frequency counts which exceed the predetermined threshold. The selection module 14 is programmed to then retrieve the selected subsets 20 of positioning data from the server database 10 and to provide them to the data transfer module 16 which provides the selected subsets 20 of positioning data to the mobile user device 1 which uses that data to update the contents of the local database 6.

Typically, one or more of the selected subsets 20 of positioning data provided to the mobile user device 1 will not be associated with the geographical location or geographical region in which the mobile user device is currently located. One or more of the selected subsets 20 of positioning data provided to the mobile user device 1 are typically provided to the mobile user device 1 in anticipation that it will move to the geographical region associated with the selected subsets 20 based on its prior whereabouts.

It may be that only some of the subsets 20 of positioning data from the server database 10 are considered by the selection module 10 for transfer to the mobile user device 1. For example, it may be that the selection module 14 considers subsets 20 of positioning data relating to geographical regions within a predetermined radius of a current location of the mobile user device 1.

It will be understood that particular geographical locations or geographical regions may be regularly occupied by the user at particular times of the day (and/or on particular days of the week), but not at others. In order to take this into account, the controller 2 may be programmed to dynamically update the customised user data 12 from a master database of customised user data (which may be stored in a slower memory of the controller 2 than the said customised user data 12) over time to include only references to those geographical locations or geographical regions which the user is likely to occupy at any given time (or within a limited subsequent time period). In this case, the data identifying the geographical locations or geographical regions previously occupied by the user in the master database is typically associated with one or more time references indicative of when the user occupied that position. The time references may comprise (for example) actual times at which the user occupied that position, a mean time at which the user has occupied that position, or an earliest time on any given day at which the user has occupied that position. The time references may also be day, week or month specific. It will be understood that the process of dynamically updating the customised user data takes into account the said time references. This helps to ensure that only positioning data which has a high probability of being relevant for estimating the location of the device 1 needs to be stored on the device 1.

Alternatively, as illustrated in FIG. 3, the data identifying the geographical location or geographical region previously occupied by the user in the customised user data 12 may be associated with one or more time references indicative of when the user occupied that position. Again, the time references may comprise (for example) actual times at which the user occupied that position, a mean time at which the user has occupied that position, or an earliest time at which the user has occupied that location on any given day. The time references may also be day, week or month specific. In this case, the selection algorithm employed by the selection module 14 selects the said subsets 20 of positioning data from the server database 10 based on customised user data relevant to the current time (or a subsequent time period) taking into account the time references associated with the customised user data 12, so as to provide the mobile user device 1 with positioning data which has a high probability of being relevant for estimating the location of the device 1.

In combination with providing the mobile user device 1 with selected subsets 20 of positioning data from the server database 10, the controller 2 may be programmed to provide the mobile user device 1 with positioning data concerning a geographical region comprising a (e.g. currently) estimated location of the mobile user device 1 (and/or neighbouring geographical regions) whether or not they are identified in the customised user data as having been previously occupied by the user or whether they have associated frequency counts (or other metrics) greater than the predetermined threshold. Thus, two mobile user devices located at substantially the same location may be provided with positioning data concerning the region in which they are based (and/or one or more neighbouring regions), together with additional data which is different for each of the devices (as it is selected based on the customised user data for the user of that device).

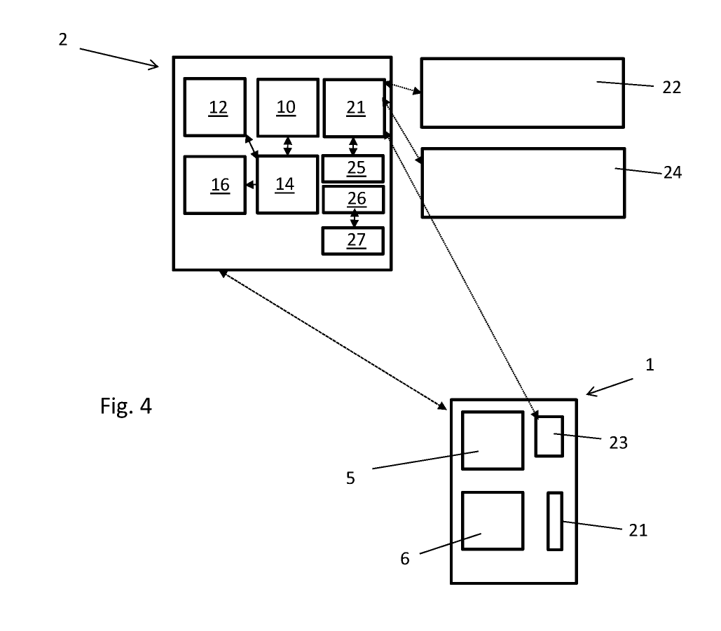

The customised user data 12 may comprise one or more parameters derived from data collected from one or more social networks relating to the said user of the mobile user device and/or internet browsing data from one or more web profiles of the said user of the mobile user device indicative of a possible future activity of the user. In order to generate such parameters, the controller 2 may comprise (at least part of) an aggregator module 21 (see FIG. 4) programmed to aggregate and mine data from one or more social networks 22 (one is illustrated in FIG. 4) relating to the said user of the mobile user device 1 and/or internet browsing data (e.g. browsing history) 23 of the user or data from one or more web profiles 24 (not shown) of the user. A portion of the aggregator module 21 may be provided on the mobile user device 1. The aggregator module 21 may also gather data from applications which bundle data from social networking applications (e.g. snapp, foursquare), and/or from a message history relating to messages sent, received and/or stored by the mobile user device 1 (subject to the permission settings on the mobile device being set appropriately).

The aggregator module 21 filters the gathered data, keeping time and location data together with selected general text from which information regarding the user's activity habits can be determined. The controller 2 may further comprise a sorting module 25 programmed to sort (e.g. chronologically, e.g. by the time the data was entered or posted by the user) the collected data and a parameter generation module 26 programmed to derive from the sorted aggregated data one or more parameters which are indicative of a possible future activity of the user. The parameter generation module 26 may run continuously or periodically to dynamically update the customised user data 12 with the parameters it generates.

The controller 2 may further comprise a pattern identification module 27 which is programmed to process the data gathered by the aggregator module 21 in order to extract potentially useful information regarding the user. More specifically, the data may be processed by the pattern identification module 27 to determine patterns in the sorted data, such as repeated activities, or categories of place visited, by the user (which may be indicated by check-in data at locations having particular categories or by repeated keywords appearing in posts on social networking sites). The patterns determined by the pattern identification module 27 are then passed to the parameter generation module 26 which then generates one or more parameters indicative of one or more possible future activities of the user.

In some embodiments, a database of (e.g. well-known) keywords may be provided. In this case, the sorted, aggregated data may be compared to the database of keywords by the parameter generation module 26. Keywords from the keywords database which match (e.g. keywords within) the sorted, aggregated data may be added to the customised user data 12 by the parameter generation module. The pattern identification module 52 may determine matches between the aggregated data and natural language keywords from the keywords database and the parameter generation module 26 (which is typically in data communication with the keywords database, where provided) adds the matching keywords (permanently or, more typically, temporarily) to the customised user data 12.

The said parameters may comprise one or more natural language keywords which repeatedly appear in the collected data. The said parameters may further comprise one or more times or time periods, which may be time references associated with the collected data from which the natural language keywords are derived, or they may be times specified in the collected data by the user and which have been determined to be associated with the natural language keywords.

It may be that the metric associated with the geographical locations or geographical regions in the customised user data begins as a frequency count as discussed above. Over time, one or more (or each) of the positions or regions provided in the customised user data 12 may be associated with a category of activity or a category of place. For example, if the geographical location or geographical region comprises a coffee shop, or a plurality of coffee shops, that location or region may be associated with a “coffee drinking” or “coffee shop” category in the customised user data 12. This category data can be, for example, manually input by the user or obtained from third party mapping applications such as Google Places or other location specific residential, business or retail directories.

The parameters derived from the social networks relating to the said user of the mobile user device and/or internet browsing data from one or more web profiles of the said user of the mobile user device may be used to provide a more sophisticated metric in the customised user data 12 with which to determine (e.g. rank) the relevance of particular geographical locations or geographical regions to the user of the mobile device. In one example, the natural language keywords derived from the social networks relating to the said user of the mobile user device and/or internet browsing data from one or more web profiles of the said user of the mobile user device are compared to the categories associated with the geographical locations or geographical regions provided in the customised user data and, if there is deemed to be a match, the metric associated with that location or region in the customised user data is (at least temporarily) incremented to indicate an increased confidence that the user will soon occupy that geographical location or geographical region. This may cause the metric to rise above the predetermined threshold, causing positioning data relating to that location or region to be selected by the selection module 14 and transferred from the server database 10 to the local database 6 on the mobile user device 1.

It may be that the positioning data of the server database 10 is referenced to one or more activity categories or categories of place (typically in addition to the geo-referencing discussed above). The activity categories or categories of place may be determined from data manually input by users of multiple mobile user devices, or obtained from third party mapping applications such as Google Places or other location specific residential, business or retail directories.

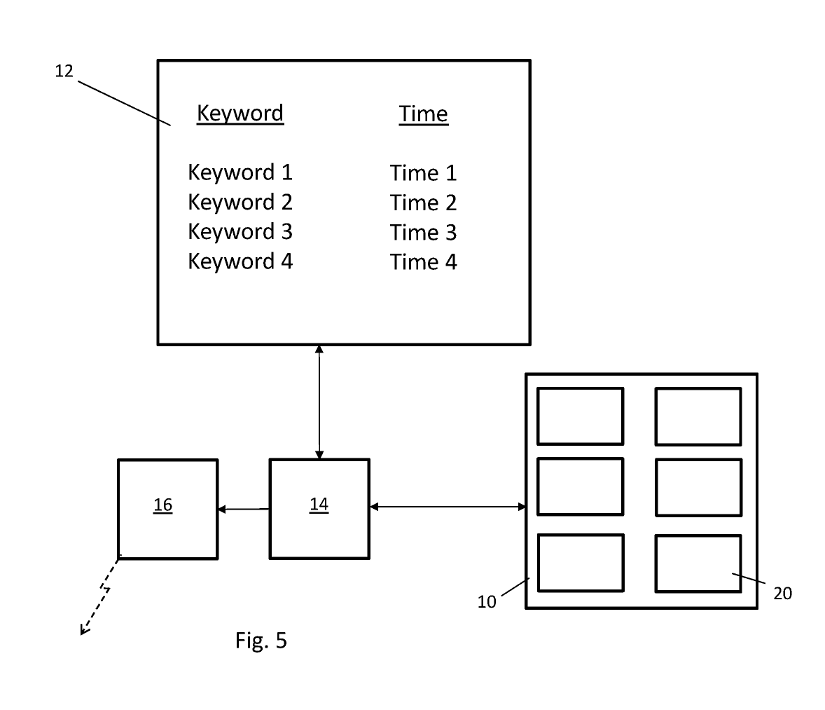

The parameters derived from the social networks relating to the said user of the mobile user device and/or internet browsing data from one or more web profiles of the said user of the mobile user device may additionally or alternatively be stored in the customised user data 12 and used more directly to select subsets 20 of positioning data from the server database 10 to provide to the mobile user device 1. In one example, illustrated in FIG. 5, one or more natural language keywords derived from the aggregated data are stored, together with respective time references, in the customised user data 12. The selection module 14 is programmed to predict a category (and time if available, and even approximate location if for example the natural language keywords relate to a place name) of possible future activity of the user based on the natural language keywords. For each natural language keyword, the selection module 14 is programmed to select one or more subsets 20 of positioning data (e.g. relating to geographical regions within a predetermined radius of a current location of the user, which may be inferred from the location of the device) from the server database 10 which are associated with a category of activity relevant to the said keyword, and to provide the selected subsets 20 to the device 1 via the data transfer module 16 at, or preferably in advance of, the time reference associated with the natural language keyword. As above, it will be understood that the time element is optional.

In another example, the geographical locations or geographical regions provided in the customised user data are grouped together by associated activity or place category to determine one or more activity or place category patterns of the user. If a particular activity category is associated with each of a plurality of geographical locations or geographical regions in the customised user data 12, the selection module 14 may be programmed to select subsets 20 of positioning data from the server database 10 relating to that activity or place category and to provide them to the mobile user device 1 by way of the data transfer module 16. Better still, if a particular activity or place category is associated with each of a plurality of geographical locations or geographical regions in the customised user data 12, and some or all of those geographical locations or geographical regions are associated with time references which are similar or identical, the selection module 14 may be programmed to select subsets 20 of positioning data from the server database 10 relating to that activity or place category and to provide them to the mobile user device 1 at, or in advance of, the time indicated by that time reference by way of the data transfer module 16.

It will be understood that particular categories of activity may be performed (or particular categories of place may be visited) by the user at particular times of the day (and/or on particular days of the week), but not at others. In order to take this into account, the controller 2 may be programmed to dynamically update the customised user data 12 from a master database of customised user data (which may be stored in slower memory than the said customised user data 12) over time to include only references to those activity categories or categories of place which the user is likely to perform or visit at any given time. In this case, the data identifying the activity or place categories of interest to the user in the master database are typically associated with one or more time references indicative of when the user performed an activity or visited a place of that category. The time references may comprise (for example) actual times at which the user occupied a position related to that activity or place, a mean time at which the user has occupied a position related to that activity or place, or an earliest time at which the user has occupied a position related to that activity or place. The time references may also be day, week or month specific. This helps to ensure that only positioning data which has a high probability of being relevant for estimating the location of the device 1 needs to be stored on the device 1.

Alternatively, the activity or place categories in the customised user data 12 may be associated with one or more time references. The time references may comprise (for example) actual times at which the user occupied a position related to an activity or place in those categories, a mean time at which the user occupied a position related to an activity or place in those categories, or an earliest time at which the user has occupied a position related to an activity or place in those categories. The time references may also be day, week or month specific. In this case, the selection algorithm employed by the selection module 14 selects the said subsets 20 of positioning data from the server database 10 taking into account the current time and the time references associated with the customised user data 12 so as to provide the mobile user device 1 with positioning data which has a high probability of being relevant for estimating the location of the device 1.

More generally, the controller 2 may be programmed to generate customised user data relating to activity patterns of the user based on one or more (typically two or more) geographical locations or geographical regions occupied by the user of the device. For example, “home” or “work” locations of the user may be derived from the said geographical locations or geographical regions occupied by the user of the device. It may be that the controller 2 takes into account the time references associated with one or more locations previously occupied by the user when generating customised user data. For example, if it is determined that the user (typically) occupies a pair of train stations between 0700 and 0900 on weekdays, a natural language keyword “commuter” (which is indicative of a commuting activity pattern) may be generated and stored in the user's customised user data. It may be that the natural language keyword is associated with a geographical limitation (e.g. “commuter between Glasgow and Edinburgh”). However, if it is determined that the user occupies the same pair of train stations at 1000 on a weekend, alternative natural language keyword “day-tripper” (which is indicative of a day tripper activity pattern different from the commuting activity pattern) may instead be generated and stored in the user's customised user data.

The server database 10, or an additional server database in data communication with the selection module 14, may comprise location specific geographical descriptive data such as mapping data or geographical descriptive data describing or otherwise relating to one or more geographical features, geographical spatial features, amenities, businesses or brands. In this case, the selection module 14 is programmed to select location specific geographical descriptive data from the database to provide to the mobile user device 1, which the mobile user device 1 (e.g. the positioning module 5) can use to improve estimates of its position. Location specific geographical descriptive data is typically selected by the selection module 14 from the database responsive to a determination that the said location specific geographical descriptive data meets one or more relevance criteria associated with the said customised user data 12 (and the data transfer module 16 is typically programmed to provide said data to the mobile user device). For example, the selected location specific geographical descriptive data relates to a discrete geographical region to which a selected subset of positioning data is geo-referenced. The geographical descriptive data typically comprises reference locations of each of one or more geographical spatial features of the said geographical region such as doors, corridors, turning points, floor change points or regions, staircases, elevators, escalators etc which can be used by the mobile user device to adjust its estimated location, e.g. to better match the geographical descriptive data (e.g. the mobile user device 1 may adjust estimates of its location from a first estimated location to a second estimated location taking into account to the contents of the geographical descriptive data). The geographical descriptive data may further comprise one or more paths or routes along which the user can travel within the said indoor region which can be also used by the mobile user device to adjust its estimated location, e.g. to better match the said routes (e.g. the mobile user device 1 may adjust estimates of its position to lie on the said routes). The geographical descriptive data may further comprise the location of each of one or more reference points within the indoor region, and the mobile user device 1 may use such reference point to adjust an estimate of its position.

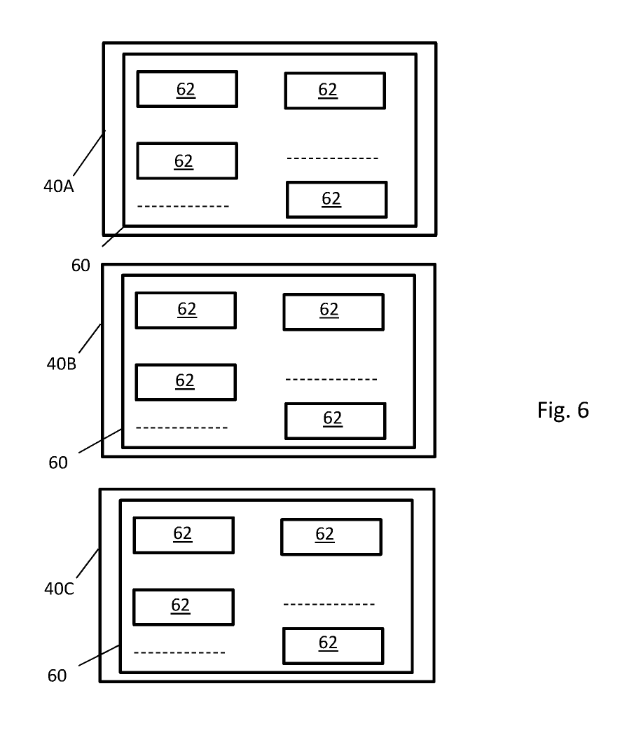

FIG. 6 illustrates the structure of locally stored positioning data in the local database 6. The data is stored as data structures relating to different geographical regions 40A, 40B, 40C. In a simple embodiment, these different locations may be squares of a certain size, (for example 100 m, 250 m or 1 km width and depth, or 0.01 degrees of latitude and longitude). However, there is no requirement for these regions to be the same size and shape as each other. Smaller regions may be defined where there is a high density of electromagnetic signal sources, and larger regions may be defined where there is a low density of electromagnetic signal sources. Regions may be ascribed to specific structures, or parts thereof, such as a building, a floor of a building, an airport terminal, a shopping centre, a sports stadium.

For each geographic region in respect of which the local database 6 currently stores data, the local database 6 stores positioning data comprising radio frequency electromagnetic signal source data 60. The radio frequency electromagnetic signal source data 60 comprises, for each of a plurality of radio frequency electromagnetic signal sources 62, an identifier of that radio frequency electromagnetic signal source (e.g. MAC address), the position of that radio frequency electromagnetic signal source (as per the best available estimate), specified as coordinates (which may be 2D or 3D in different embodiments), and a parameter specifying the signal strength of that radio frequency electromagnetic signal source (which may be a numerical value or another parameter from which signal strength can be deduced, e.g. the type of that radio frequency electromagnetic signal source). Additional data concerning the radio frequency electromagnetic signal source may be received from the server database 10 and stored for use in positioning, for example, an estimate of the accuracy of the position of the radio frequency electromagnetic signal source, a time stamp as to when the radio frequency electromagnetic signal source was features or most recently detected, and so forth.

The local database 6 also stores, for each region, data 64 about the radio frequency electromagnetic signal sources 62 for that region. This data may, for example, include data concerning the number or density of radio frequency electromagnetic signal sources in that region, the age or maturity of the data concerning radio frequency electromagnetic signal sources, the minimum, maximum and/or average signal strength of radio frequency electromagnetic signal sources in that region, the minimum, maximum and/or average uncertainty in the estimated position of radio frequency electromagnetic signal sources in that region. This data can at least in part be computed by the mobile user device 1 when it receives positioning data and updated positioning data from the controller, or it may be received at least in part with positioning data, including updated positioning data, received from the controller.

The data stored in the server database 10 generally corresponds to the locally stored positioning data, but includes additional data required by the controller 2 but not by the mobile user device 1. The data stored in the server database 10 is typically also grouped by geographical region and in an example embodiment, the following data is stored for each geographical region:
An identifier of, currently estimated position of, and estimated signal strength of individual radio frequency electromagnetic signal sources in that geographical region
Additional data concerning the individual radio frequency electromagnetic signal sources, such as when they were first detected, when they were last detected, how often they have been detected, the frequency with which data concerning them has been updated, estimates of the accuracy of the position and signal strength estimates
The time of the last update to the data, the age of the data, the frequency with which the data concerning that geographical region has been updated
Parameters concerning the received signal strength of radio frequency electromagnetic signal sources in the geographical region (e.g. minimum and maximum signal strength in that region, standard deviation of signal strength in that region)
Data concerning the coverage (e.g. fraction of an area or volume which is within a certain distance of at least two, or at least three radio frequency electromagnetic signal sources) or maturity of the data in that geographical region.

The maturity of the data is a parameter which starts with a low value when a geographical region is first introduced to the positioning data and new observations lead to significant changes in the accuracy and quality of positioning data and increases as the quality of data concerning the geographical region improves and additional observations have less effect. It may for example be calculated using the following formula:

M=w1(N0/Na)+w2(SUM(Mi)/(N0))+w3(N1/Na)+w4(std(Di)/std0) (5)

Where M is the calculated maturity, w1, w2, w3 are weighting factors, N0 is the total number of radio frequency electromagnetic signal sources in the geographical region for which there is an estimated position, Na is the total number of radio frequency electromagnetic signal sources detected in the geographical region, Mi is the maturity of the data for radio frequency electromagnetic signal source i, N1 is the number of radio frequency electromagnetic signal sources for which the data (estimate of location and/or signal strength) passes a quality check, being a set of predetermined thresholds for accuracy, time since first or most recently detected, number of times it has been observed etc., Di is the distance between the centre of the geographical region and the location of radio frequency electromagnetic signal source i, std0 is the standard deviation of an optimum distribution of radio frequency electromagnetic signal sources. Mi may be calculated for an individual radio frequency electromagnetic signal source using the formula:

Mi=w5(N2/Nt)+w6(std(Di)/std0)+w7(C/C0) (6)

Where N2 is the number of observations of radio frequency electromagnetic signal source i which meet a predetermined quality threshold, Nt is the total number of observations of radio frequency electromagnetic signal source i, Di is the distance between the centre of geographical region and the location of individual observations of the radio frequency electromagnetic signal source, std0 is the standard deviation of an optimum distribution of observations, C is the area around each radio frequency electromagnetic signal source within a predetermined distance of at least one observation of the radio frequency electromagnetic signal source meeting a predetermined quality threshold and C0 is the area around each radio frequency electromagnetic signal source within a predetermined distance of at least one observation if there were an optimum coverage of observations of the radio frequency electromagnetic signal source.

Referring back to FIG. 2, the mobile user device 1 may further comprise a validation module 30 which is programmed to carry out a data validation procedure on positioning data in the local database 6 and, depending on the quality of the data, to accept or reject additional positioning data being offered by the controller 2. It may be that, once the said subsets of positioning data have been selected by the selection module 14, the data transfer module 16 is programmed to send an initial message (not comprising the selected subsets of positioning data) to the mobile user device to identify the geographical regions in respect of which positioning data has been selected. It may be that the validation module 30 performs a data validation procedure on the data (if any) stored in the mobile user device 1 relating to those regions to determine whether the mobile user device 1 already has reliable data for the positioning module 5 to use to estimate the location of the mobile user device 1. If the validation module 30 determines that insufficient (or inaccurate) data is available, it may request the data transfer module 16 to proceed with the transfer of the selected subsets of positioning data to the mobile device 1.

The validation procedure takes into account issues such the accuracy of the positioning data stored in the local database 6 (e.g. a measure of the accuracy of the estimated position of a radio frequency electromagnetic signal source), a time stamp regarding when the data was created or last updated, or the time of the most recent measurement (by another mobile user device) of a radio frequency electromagnetic signal source. Other factors may include the maturity of the data, or its consistency.

The validation procedure aims to provide the positioning module 5 with the most accurate positioning data available, and determine when updates should be requested or accepted from the server database 10. For example, if the estimate of the position of some of the radio frequency electromagnetic signal sources in the region considered by the validation procedure is more accurate than the estimate of the position of other radio frequency electromagnetic signal sources, the validation procedure may pass only data concerning the latter to the positioning module 5. If there are relatively few radio frequency electromagnetic signal sources, or a time (e.g. time of creation, time of receipt) of the positioning data concerning some or all of the radio frequency electromagnetic signal sources is sufficiently old, the validation module 30 may request updated positioning data.

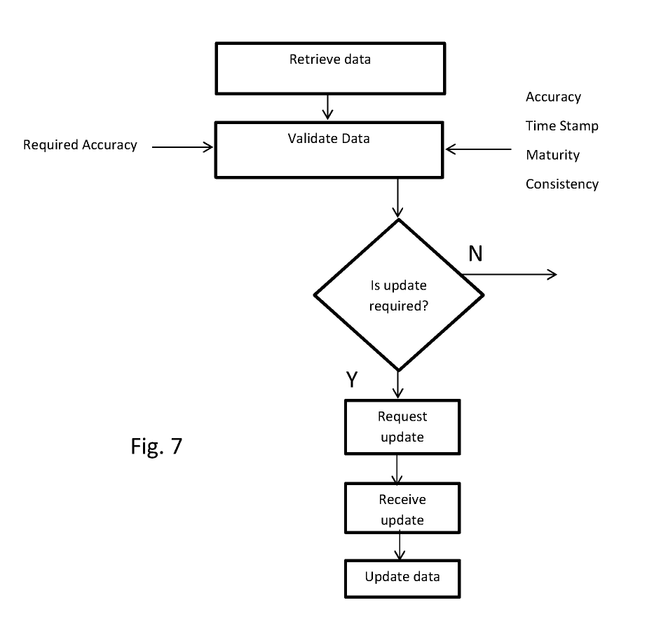

The function of the validation module 30 is illustrated in FIG. 7. Data stored in the local database 6 relating to the geographical locations or regions to which the selected subsets of positioning data are geo-reference are retrieved and validated. The validation procedure takes into account requirements, such as a required level of accuracy, which varies depending on circumstances. The required level of accuracy may be increased responsive to detection that a user is relying on their current location for accurate (e.g. pedestrian or indoor) navigation, or the mobile user device is executing an application which has a particular requirement for accurate data. The validation procedure may take into account other requirements, such as current charge status of a battery of the mobile user device. When the charge status is relatively low, it may be less likely to request an update of positioning data.

If no update is required, the data validation module 30 may select or deselect positioning data (from the local database 6) for use by the positioning module 5, and pass selected data to the positioning module 5 (or flag in the local database 6 that the said positioning data is not in need of an update). If an update is required, instead of passing the selected data to the positioning module 5, the positioning module 5 may indicate which data should not be used, for example, by passing a list of references to data in the local database 6 or by flagging data in the local database 6.

Generally, an update is accepted if the available positioning data concerning a location does not meet one or more quality criteria. Updates may be provided in advance of being required, for example, before a mobile user device enters a building where detailed positioning information is likely to be required or before a mobile user device switches mode from vehicle to pedestrian navigation.

If it is determined that an update is required, an update message (which is effectively a request for the data to be sent from the controller 2 to the mobile user device 1) is sent to the controller 2 to accept the update from the server database 10. The update message may comprise data concerning properties of the positioning data stored in the local database 6, particularly properties concerning the quality of that data. For example, as well as a reference to a geographical region, the update message may include one or more of:
a time associated with the locally stored positioning data (e.g. time of creation or last update, time of previous transmission from the controller or time of receipt by the mobile user device) and/or version information
one or more metrics concerning the quality of the locally stored positioning data, e.g. accuracy of or uncertainty in position estimates, or the density of radio frequency electromagnetic signal sources, or the maturity of the positioning data.

Provided that a communication to the controller is available, it should receive the update message and respond by transmitting updated positioning data. The remote server may not always respond. For example, if there is no newly updated data concerning the relevant geographical region in the server database, or if an update would be of relatively little assistance, the remote server may determine not to respond by transmitting updated positioning data.

In order to determine whether to send updated positioning data, or which data to send, the controller 2 processes the received data concerning properties of the locally stored positioning data to determine whether it meets one or more quality criteria. The controller may calculate corresponding properties for positioning data stored in the server database and compare the two. For example, the controller 2 may determine whether it has positioning data which is newer than the positioning data stored locally by the mobile user device 1 by more than a first predetermined threshold and/or positioning data in which the estimates of the position of radio frequency electromagnetic signal sources are more accurate in positioning data stored in the server database 10 than locally by the mobile user device 1 by more than a second predetermined threshold. The controller 2 may for example calculate a weighted average of a plurality of properties of the locally stored positioning data.

In some embodiments, the controller 2 instead processes stored data concerning properties of the positioning data previously sent to the mobile user device 1, which may be as simple as the time or version identifier of the last update sent to the mobile user device 1 concerning a geographical region, rather than receiving relevant properties in the update message. The controller 2 may store data concerning when the mobile user device 1 last received updated positioning data, or last received updated positioning data concerning a particular geographical region, to enable it to determine whether and to what extent updated positioning data will assist the mobile user device 1.

The controller 2 may send updated positioning data in respect of a different geographical region to that referred to the update message, for example a smaller, larger, overlapping or proximate geographical region. This may for example arise if the controller 2 is aware of new (or moved or deleted) radio frequency electromagnetic signal sources, or significant changes in geographical regions which are near the location of the mobile user device 1, or to provide some additional data to the mobile user device 1 as a buffer ahead of further movements of the mobile user device 1.

The update message from the mobile user device 1 to the controller 2 may comprise importance data or requirement data which the controller 2 can interpret to determine what updated positioning data to transmit to the mobile user device 1, and when it should transmit it. For example, if a mobile user device 1 requires very accurate positioning data immediately, it may transmit importance data requesting that it receives updated data urgently and the controller 2 may priorities transmitting relevant updated positioning data to that mobile user device 1. If the controller 2 determines that the additional or newer positioning data which it has available will be of relatively little assistance to the mobile user device 1 it may deprioritise and thereby potentially delay the transmission of updated positioning data to the mobile user device 1.

Provided that updated positioning data is sent by the data transfer module 16 of the controller 2, it should be received by the mobile user device 1 and then used to update the stored positioning data in the local database. The updated data can then be passed to the positioning module 5.

It may be that the data that is received is an update of positioning data, rather than a request to make a complete replacement of the positioning data concerning a region. For example, updated positioning data may comprise data concerning radio frequency electromagnetic signals sources not previously included in the stored positioning data, or new estimates of the position of radio frequency electromagnetic signal sources.

This enables the amount of data which is transmitted to be minimised, while still retaining data of sufficient quality to enable the positioning module to carry out positioning to required level of accuracy. Of course, in some circumstances, a request to replace all of the positioning data concerning a geographical region could be made, for example if all of the data concerning a particular region has been deleted, and is now required once more. A mobile user device may replace the positioning data concerning a geographical region more frequently when connected to the internet through a wired connection, or when charging, than when connected to the internet through a cellular telephone network while not being charged.

Accordingly, the mobile user device 1 and controller 2 both regulate the quality of the positioning data stored on the mobile user device, avoiding excessive data transfer to the mobile user device 1 but prioritising the transfer to the mobile user device of updated positioning data to minimise poor performance of the positioning system.

It may be that the data transfer module 16 is programmed to transmit the selected subsets of positioning data from the server database 10 to the mobile user device 1 responsive to a determination that an active data communication channel having a bandwidth greater than a predetermined threshold bandwidth is available for transferring data from the server database 10 to the mobile user device 1. For example, the data transfer module 16 may be programmed to transmit the selected data from the server database 10 to the mobile user device 1 responsive to a determination that an active data channel of particular data communications technology (e.g. 3G mobile telecommunications channel, 4G mobile telecommunications channel, over the fixed line internet by way of a Wi-Fi connection) is available for transferring data from the server database 10 to the mobile user device 1. It may be that the selected subset(s) of positioning data are transmitted to the device earlier than otherwise planned responsive to such a determination.

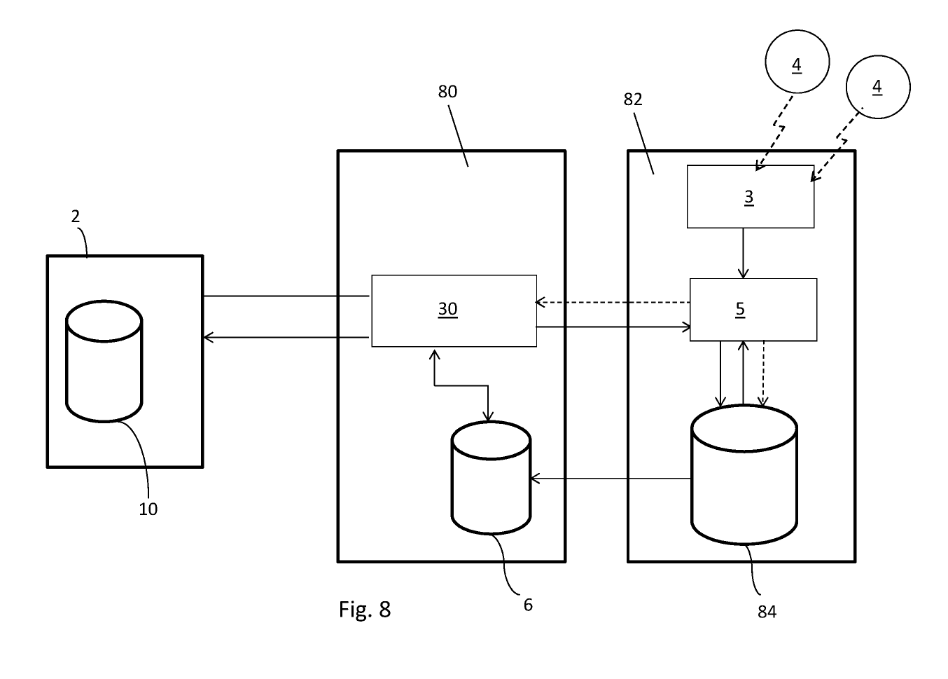

In alternative embodiments, the functionality of the mobile user device 1 may be distributed between one or more components of the mobile user device 1 which are in wireless communication with each other, and typically both carried around at once by the user. With a reference to FIG. 8, the mobile user device 1 comprises a mobile telephone 80, and a separate wearable component 82, such as a watch or glasses, except that in this example embodiment the validation module 30 and local database are located in the body of the mobile telephone 80, and the radio antenna 3, and positioning module 5, are located in the wearable accessory 82, along with a stored buffer 84 which receives selected, validated positioning data from the mobile telephone 80, and transmits requests for selected, validated positioning data to the data validation module 30 over a wireless link.

Some illustrative examples of various implementations of the present invention now follow.

### Example 1

As discussed above with reference to FIG. 3, customised user data relating to the user of the device may comprise a plurality of locations previously visited by the user, each of the said plurality of locations being associated with a frequency count indicative of a number of times the said locations have been visited by the user, and each of the said locations may also be associated with one or more activity categories or categories of place. In this example, one or more of the locations in the customised user data is associated with a “restaurant” category. The user posts a message on a social networking website indicating that she is planning to visit a restaurant in the next few hours. This message is picked up by the aggregator module 21 and the parameter generation module 26 generates one or more parameters indicating that a possible future activity category of the user is “visiting a restaurant” and/or that a possible future category of place to be visited by the user is a “restaurant”, and that the activity is expected to be performed within a few hours (e.g. keyword: “restaurant” and time reference: “next 0-5 hours”). The selection module 14 then selects one or more subsets of positioning data from the server database 10 which is/are geo-referenced to geographical regions comprising restaurants previously visited by the user (or at least referenced to geographical regions comprising a location previously visited by the user and being associated with “restaurants” in the customised user data). The selection module 14 then provides the selected subsets of positioning data to the data transfer module 16 which transmits the selected subsets of positioning data to the mobile user device 1 so that by the time the user visits a restaurant, the mobile user device 1 will have the positioning data it needs for the device to estimate its position and thus for the user to navigate and/or send an accurate reference to her location. The data validation procedure discussed above may also be performed at this stage.

It will be understood that in alternative examples, the selection module 14 selects only subsets of positioning data referenced to geographical regions comprising a location previously visited by the user and being associated with “restaurants” in the customised user data if the said location has an associated frequency count which exceeds a predetermined threshold. It will also be understood that the selection module 14 may select additional subsets of positioning data relating to other geographical regions being associated with “restaurants” (e.g. including one or more regions not previously visited by the user). The selection module 14 may limit its selection of positioning data by a current location of the device (e.g. only positioning data within a predetermined radius of a current location of the device) and/or by time of day (e.g. only select positioning data relating to geographical regions comprising a location previously visited by the user at a certain time or certain times of day). It will also be understood that instead of posting the message indicative of her intention to visit a restaurant on a social network, the user may have input data indicating this directly to the mobile user device 1.

It will also be understood that one or more of the geographical regions to which the selected positioning data is referenced may comprise one or more indoor regions in which the mobile user device 1 may not be able to use a satellite positioning system which it is otherwise able to use to estimate its position. By providing the mobile user device with positioning data allowing the mobile user device 1 to estimate its position before the user visits the indoor region, the user can navigate and accurately estimate its position indoors without having to perform further communication with the server. In this case, geographical descriptive data relating to the indoor region may be further selected by the selection module 14 from the server database 10 (or alternative database in data communication with the selection module 14) and provided to the mobile user device 1 by the data transfer module 16.

The mobile user device 1 may obtain updated positioning data from the server database 10 relating to the geographical locations or geographical regions to which the selected subsets of positioning data are referenced in the server database 10 one or more times after the initial selection and data transfer of the selected subsets of positioning data to ensure that the positioning data on the mobile user device 1 is fully up to date when the user goes to use it.

### Example 2

In this example, the customised user data 12 includes one or more parameters indicative of a geographical region which the user is visiting for a limited time. For example, the user may have manually input to the mobile user device 1 that she is going on vacation to a particular city or country, or that she is attending an event at a particular venue. Additionally or alternatively, this information may be inferred by the aggregator module 21 and parameter generation module 26 from one or more messages posted by the user on a social network or from internet browsing data of the user or from one or more patterns of movement of the device 1. In this case, the selection module 14 selects one or more subsets of positioning data relating to the said city, country or venue (e.g. positioning data relating to the top attractions of a city, or positioning data relating to the venue or surrounding area, or positioning data along a route between a current position of the device 1 and the venue) which are provided to the mobile user device 1 by the data transfer module 16, typically in advance of when they will be required.

### Example 3

In this example, the customised user data 12 comprises data concerning a transportation related activity pattern. More specifically, the customised data comprises the keywords “railway, commuter, Edinburgh, Glasgow” indicating that the user commutes between Edinburgh and Glasgow by train. The customised data may also comprise time reference information indicating that the user commutes by train between Edinburgh and Glasgow at times between 7 am and 9 am Monday to Friday. In this case, the selection module 14 selects positioning data from the server database 10 geo-referenced to one or more discrete geographical regions surrounding Edinburgh train station, one or more discrete geographical regions surrounding Glasgow train station and one or more geographical regions between Edinburgh train station and Glasgow train station. The selection module 14 may be further programmed to select positioning data geo-referenced to geographical locations or regions between a “home” location of the user and a “home” train station (e.g. Edinburgh) and positioning data geo-referenced to geographical locations or regions between a “work” location of the user and a “work” train station (e.g. Glasgow) to enable the mobile user device 1 to estimate its position accurately at any point between home and work locations of the user.

Typically the selected subset(s) of positioning data is provided to the mobile user device 1 in advance of when it may be required. It may be that the user typically follows this activity pattern regularly, and so it is associated in the customised user data with a high confidence indicator. Accordingly, it may be that the positioning data relating to this activity pattern is stored permanently (e.g. without an automatic expiration time) on the mobile user device, albeit it may be updated when better positioning data is available (e.g. after following the data validation procedure discussed above).

### Example 4

In this example, the user occupies a new geographical location or new geographical region in which she has never previously been. The customised user data comprises a time reference generated by the parameter generation module 26 from data picked up by the aggregator module 21 from a message posted on a social network, the said time reference being indicative of how long the user expects to be in that geographical location or region. Furthermore, the customised user data comprises data identifying one or more possible future destinations of the user (e.g. a location parameter generated by the parameter generation module 26 from data picked up by the aggregator module 21 from a message posted on a social network, obtained from a manual input of the user, or inferred from one or more activity category patterns or category of place typically occupied by the user).

The selection module 14 is programmed to select positioning data from the server database 10 relating to the said new geographical location or new geographical region, the selected data being provided to the mobile user device 1 by the data transfer module 16. The selection module 14 may be programmed to allocate an expiry time to the selected data relating to the said new geographical location or new geographical region based on the time reference in the customised user data. This ensures that the data is not stored on the mobile user device 1 for longer than is necessary.

The selection module 14 may also be programmed to select one or more subsets of positioning data from the server database 10 concerning one or more geographical regions between the said new geographical location or new geographical region and the one or more possible destinations of the user. This ensures that more positioning data is provided to the mobile user device 1 from the server database 10 in a fewer number of larger data transfers (as opposed to piece meal transfer of data from the server database 10 to the device 1 as and when the device 1 enters another new location), which is more (e.g. power and/or bandwidth) efficient.

The selection module 14 (or another module of a or the server 2) may be programmed to select geographical descriptive data from the server database 10 (or other database in data communication with the selection module 14 or other module) relating to the said new geographical location or region and/or relating to one or more geographical locations or regions between the said new geographical location or region and one or more of the said possible future destinations of the device. The said geographical descriptive data may identify one or more (e.g. walking) routes which may be followed by the user between the said new geographical location or new geographical region and one or more of the possible future destinations of the device. The selection module 14 may be programmed to select one or more subsets of positioning data from the server database 10 geo-referenced to one or more geographical locations or geographical regions along the said routes. The selection module 14 may be further programmed to provide the selected subsets of positioning data, optionally together with the said geographical descriptive data, to the mobile user device 1 by way of the data transfer module 16. Again, this ensures that the positioning data required by the mobile user device 1 is provided thereto in a fewer number of large data transfers.

It will be understood that in alternative examples, the positioning data provided to the mobile user device 1 may relate to one or more routes between a location or region previously occupied by the user and one or more possible future destinations of the user (as opposed to between a new location of the user and one or more possible future destinations).

The invention thus provides for the mobile user device 1 to employ customised user data relating to the user of the device to predict future geographical locations or geographical regions of the user and/or routes which will be followed by the device, to thereby allow positioning data to be transferred from the server database 10 to the mobile user device 1 in greater volumes and in fewer data transfers than would otherwise be possible, thereby improving the efficiency of the device 1.

Further variations and modifications may be made within the scope of the invention herein described. For example, one skilled in the art will appreciate that there are other ways in which a database of positioning data may be configured. For example, in alternative embodiments, the server database of positioning data additionally or instead comprises fingerprint data, being, for each of a plurality of positions (e.g. a grid of positions), data specifying an identifier (e.g. MAC address) of radio frequency electromagnetic signals sources which may be detected at that location and their signal strength.

Thus, the positioning data stored locally on the mobile user device may comprise fingerprint data, for each of a plurality of locations within the respective region (typically specified as coordinates). Fingerprint data typically comprises a list of identifiers (e.g. MAC addresses) of Wireless Access Points (WAPs) which may be detected at that location, along with the expected strength of signals from the respective WAPs at the respective locations. The fingerprint data may comprise additional information, for example an estimate of the accuracy of some or all of the data at that location, or the time at which the signal strength data for that location was last measured (by another mobile user device), or processed. The fingerprint data for an individual region will typically comprise further data, including a time stamp as to when the fingerprint data was generated, and when it was received by the mobile user device.

Still further alternatives include storing parameters of functions which describe how the strength of signals from specific radio frequency electromagnetic signal sources varies spatially at a particular geographical location.

It is further noted that, in FIG. 1, the controller 2 and server database 10 are shown as a single integrated unit for clarity. However, one skilled in the art will appreciate that the functionality of the controller and the server database may be distributed (including replicated) across a plurality of different servers, in the same or different locations, or implemented using technology such as virtual servers. The mobile user device 1 may transmit data to one server of the controller 2 and receive data from another server of the controller 2.

It will also be understood that, typically, the controller 2 is programmed to select one or more respective subsets of positioning data from the server database 10 relevant to each of a plurality of mobile devices, and to transmit the relevant selected subsets positioning data from the server database 10 to the relevant mobile user devices. In this case, customised user data 12 is provided for each of the said mobile user devices, and each set of customised data is associated with an identifier of the user and/or mobile user device 1 which is used by the selection module 14 to identify the customised user data relevant to each user/device. This is indicated by the other mobile user devices 100 shown in communication with the controller 2 in FIG. 1.

It will be understood that, in general, all customised user data specific to a user of a mobile device should be collected and generated in accordance with an appropriate privacy policy which respects the user's right to privacy.

1. A method of providing positioning data to a mobile user device comprising a positioning module for estimating a location of the mobile user device, the method comprising: providing a database comprising positioning data for use by the positioning module of the mobile user device to estimate the location of the mobile user device; providing customised user data specific to a user of the mobile user device; selecting one or more subsets of positioning data from the positioning data provided in the said database responsive to a determination that the said subsets of positioning data meet one or more relevance criteria relating to the said customised user data; and providing the selected subsets of positioning data to the mobile user device.

2. The method according to claim 1 wherein the said customised user data is comprised in a user profile associated with the said user of the mobile user device.

3. The method according to claim 1 wherein the said customised user data comprises data concerning one or more activity patterns of the said user of the mobile user device.

4. The method according to claim 3 wherein the said one or more activity patterns comprise one or more patterns of movement of the said user of the mobile user device.

5. The method according to claim 4 wherein the said customised user data comprises one or more metrics, each of the said metrics being geo-referenced to a geographical location or geographical regions previously occupied by the said user of the mobile user device, the said metric(s) providing an indication of a probability that the user will occupy the geographical location or geographical region geo-referenced to that metric.

6. The method according to claim 3 wherein the said one or more activity patterns comprise one or more activity category patterns of the said user of the mobile user device.

7. The method according to claim 3 wherein the said one or more activity patterns comprise one or more place category patterns of the said user of the mobile user device.

8. The method according to claim 1 wherein the said customised user data comprises data derived from data aggregated from one or more social networks and/or from internet browsing data and/or an internet profile of the said user of the mobile user device.

9. The method according to claim 1 further comprising storing data from the selected subsets of positioning data on a memory of the mobile user device.

10. The method according to claim 1 wherein the positioning data stored in the said database comprises data concerning a plurality of radio frequency electromagnetic signal sources and/or signals from radio frequency electromagnetic signal sources.

11. The method according to claim 1 wherein the positioning data stored in the database comprises identifiers and positions of each of a plurality of radio frequency electromagnetic signal sources.

12. The method according to claim 1 wherein the positioning data stored in the database comprises radio frequency electromagnetic signal source fingerprint data relating to expected signal strengths detectable from each of one or more radio frequency electromagnetic signal sources at each of a plurality of positions.

13. The method according to claim 1 wherein the positioning data comprised in the said database is grouped or stored with reference to a plurality of discrete geographical regions.

14. The method according to claim 13 further comprising selecting from the positioning data provided in the said database a subset of positioning data referenced to one of the said discrete geographical regions responsive to a determination that the said discrete geographical region meets one or more relevance criteria relating to the said customised user data.

15. The method according to claim 14 wherein the step of selecting the said subset of positioning data referenced to one of the said discrete geographical regions is performed responsive to a determination that the discrete geographical region associated with the selected subset meets one or more geographical relevance criteria relating to the said customised user data.

16. The method according to claim 15 wherein the step of selecting the said subset of positioning data referenced to one of the said discrete geographical regions is performed responsive to a determination that the discrete geographical region associated with the selected subset comprises a geographical location or geographical region previously occupied by the said user of the mobile user device.

17. The method according to claim 13 further comprising predicting one or more candidate future geographical locations or candidate future geographical regions of the user of the mobile user device taking into account the said customised user data, wherein one or more or each of the subsets of positioning data selected from the database comprises positioning data referenced to a respective discrete geographical region comprising one or more of the said candidate future geographical locations or at least overlapping one or more of the said candidate geographical future regions.

18. The method according to claim 14 wherein the step of selecting the said subset of positioning data referenced to one of the said discrete geographical regions is performed responsive to a determination that the discrete geographical region associated with the selected subset comprises one or more amenities meeting one or more relevance criteria relating to the said customised user data.

19. The method according to claim 13 wherein at least one of the selected subsets of positioning data provided to the mobile user device comprises positioning data referenced to a discrete geographical region not comprising an estimated location of the mobile user device.

20. The method according to claim 1 wherein the step of selecting one or more subsets of positioning data from the positioning data provided in the said database is performed further taking into account an estimated location of the mobile user device.

21. The method according to claim 1 wherein the step of selecting one or more subsets of positioning data from the positioning data provided in the said database is performed further taking into account time.

22. The method according to claim 1 wherein the database of positioning data is provided on one or more servers, and the step of providing the selected subsets of positioning data to the mobile user device comprises transmitting the selected data from one or more of the said one or more servers to the mobile user device.

23. The method according to claim 22 wherein the step of transmitting the selected data from the server to the mobile user device is performed responsive to a determination that a data communication channel having a bandwidth greater than a threshold bandwidth is available for transferring data from the server(s) to the mobile user device.

24. The method according to claim 1 wherein one or more of the selected subsets of positioning data provided to the mobile user device are stored temporarily by the mobile user device.

25. The method according to claim 1 further comprising: the mobile user device receiving and storing positioning data relating to a geographical region; subsequently carrying out a data validation procedure to determine whether to update the said positioning data and, if it is determined that the said positioning data should be updated, receiving updated positioning data relevant to the said geographical region and updating the stored positioning data using the updated positioning data.

26. The method according to claim 1 further comprising the positioning module of the mobile user device estimating a location of the mobile user device using positioning data from the said selected subsets of positioning data provided to the mobile user device.

27. The method according to claim 1 further comprising providing location specific geographical descriptive data to mobile user device, the said location specific geographical descriptive data meeting one or more relevance criteria associated with the said customised user data.

28. The method according to claim 1 further comprising: monitoring one or more activities of the said user of the mobile user device; and generating customised user data specific to the said user of the device relating to said monitored activities.

29. The method according to claim 28 wherein the step of monitoring one or more activities of the user comprises tracking a geographical location or geographical region of the said user of the mobile user device, the method further comprising calculating one or more metrics, each of the said metrics being geo-referenced to a geographical location and/or a geographical region which has been occupied by the said user of the mobile user device and providing an indication of the probability that the said user of the mobile user device will occupy the geographical location or geographical region geo-referenced to that metric.

30. The method according to claim 28 wherein the step of monitoring one or more activities of the user comprises tracking a geographical location or geographical region of the said user of the mobile user device, the method further comprising determining from tracked geographical locations or geographical regions of the mobile user device one or more activity patterns of the said user of the mobile user device.

31. The method according to claim 28 further comprising: collecting user data relating to the said user of the mobile user device from one or more social networks and/or internet browsing data of the said user of the mobile user device; and generating one or more metrics taking into account at least a portion of the collected data, each of the said metrics providing an indication of a confidence level that the said user of the mobile user device will occupy a geographical region or geographical location in accordance with the said data.

32. The method according to claim 13, comprising providing first customised user data specific to a user of a first mobile user device; selecting one or more first subsets of positioning data from the positioning data provided in the said database responsive to a determination that the said first subsets of positioning data meet one or more relevance criteria relating to the said first customised user data; providing the first selected subsets of positioning data to the first mobile user device; providing second customised user data specific to a user of a second mobile user device; selecting one or more second subsets of positioning data from the positioning data provided in the said database responsive to a determination that the said second subsets of positioning data meet one or more relevance criteria relating to the said second customised user data; and providing the second selected subsets of positioning data to the second mobile user device.

33. The method according to claim 32 further comprising: determining that the first and second mobile user devices occupy the same discrete geographical region; and providing one or more third subsets of positioning data relating to the said discrete geographical region, or to one or more geographical regions neighbouring the said discrete geographical region, to both the first and second mobile user devices.

34. Data processing apparatus comprising:
a mobile user device comprising a positioning module for estimating a location of the mobile user device and a memory for storing positioning data; and
a controller comprising: a database storing positioning data for use by the positioning module of the mobile user device to estimate the location of the mobile user device; a memory storing customised user data specific to a user of the mobile user device; a selection module programmed to select one or more subsets of positioning data from the positioning data provided in the said database responsive to a determination that the said subsets of positioning data meet one or more relevance criteria relating to the said customised user data; and a data transfer module programmed to provide the selected subsets of positioning data to the mobile user device.
